(19) United States
(12) Patent Application Publication
(10) Pub. No.: US 2026/0089437 A1
(43) Pub. Date: Mar. 26, 2026

(54) VEHICLE-EXTERNAL SOUND REPRODUCING DEVICE AND VEHICLE DEVICE

(71) Applicant: SONY GROUP CORPORATION, Tokyo (JP)

(72) Inventors: Takehiko TANAKA, Tokyo (JP); Atsushi HOMMA, Tokyo (JP)

(73) Assignee: SONY GROUP CORPORATION, Tokyo (JP)

(21) Appl. No.: 19/110,972

(22) PCT Filed: Sep. 27, 2023
(86) PCT No.: PCT/JP2023/035307

§ 371 Date: Mar. 12, 2025

(30) Foreign Application Priority Data
Oct. 4, 2022 (JP) 2022-160585

(51) Int. Cl. H04R 1/34; H04R 1/02; H04R 1/24

(52) U.S. Cl. CPC H04R 1/345; H04R 1/025; H04R 1/24; H04R 2499/13

(57) ABSTRACT

A vehicle-external sound reproducing device reproducing a vehicle-external sound having a further added value while satisfying requirements of agreement regulations for an AVAS is provided. The vehicle-external sound reproducing device includes a sound reproducing part that is disposed inside a main body component of a vehicle and emits a sound to an outside of the vehicle. The sound reproducing part described above includes an exciter, and the exciter is installed on an inner wall of the main body component of the vehicle. The exciter described above is installed at a part at which a vehicle-external sound with a sound pressure level satisfying a predetermined requirement at a position with a predetermined distance and a predetermined height with respect to a traveling center line of the vehicle on the inner side of the main body component of the vehicle is able to be output.

### TECHNICAL FIELD

A technology disclosed in the present specification (hereinafter, referred to as “present disclosure”) relates to a vehicle-external sound reproducing device and a vehicle device reproducing a vehicle-external sound reaching the surroundings of a vehicle inside the vehicle.

### BACKGROUND ART

Since electric vehicles have operating sounds quieter than traditional vehicles, as a countermeasure against a problem that it is difficult for pedestrians to notice approach of a vehicle, vehicle approach notification devices (Acoustic Vehicle Alerting Systems (AVAS)) for alerting the approach of a vehicle to pedestrians and the like have been devised. Agreement regulations for AVAS were established by the United Nations in 2016, and, in Japan, it has been mandatory to equip applicable vehicles released after March 2018 with AVAS. The agreement regulations R138 relating to AVAS specify vehicle speeds that are subject to these regulations, a required sound pressure level, changes in frequency characteristics of a sound corresponding to the vehicle speed, and the like.

For example, a vehicle approach notification sound control device that includes a detection means for detecting target objects around a subject vehicle and a control means continuously changing the frequency of a notification sound used for notification of those around the subject vehicle of approach of the subject vehicle within a predetermined frequency range in a case in which the target object described above has been detected and alerts pedestrians and the like has been proposed (see PTL 1).

While a vehicle-external sound generating device formed from a speaker and the like is, for example, installed inside a hood or within a bumper, it is difficult to discharge sound to outside of the vehicle without the sound quality deteriorating. In addition, since a speaker installed outside the vehicle requires a waterproof function, the reproduction frequency band is not very wide, and the sound quality is not satisfactory for audio listening.

### CITATION LIST

### Patent Literature

PTL 1: JP 2022-11195A
PTL 2: WO 2021/049165
PTL 3: JP 2005-33593A

### SUMMARY

### Technical Problem

An object of the present disclosure is to provide a vehicle-external sound reproducing device and a vehicle device reproducing a vehicle-external sound having added values while satisfying the requirements of the agreement regulations for the AVAS.

### Solution to Problem

The present disclosure is in view of the problems described above, and a first aspect thereof is a vehicle-external sound reproducing device including a sound reproducing part that is disposed on an inner side of a main body component of a vehicle and radiates a sound to an outside of the vehicle.

The sound reproducing part described above includes an exciter, and the exciter is installed on an inner wall of the main body component of the vehicle. The exciter described above is installed at a part at which a vehicle-external sound with a sound pressure level satisfying a predetermined requirement at a position with a predetermined distance and a predetermined height with respect to a traveling center line of the vehicle on the inner side of the main body component of the vehicle is able to be output. More specifically, the exciter described above is installed at least at one part of an inner wall of a front bumper, an air intake duct, and an undercover.

Alternatively, the sound reproducing part described above includes a speaker and a reflection plate that is installed in front of the speaker and reflects a radiated sound of the speaker. The sound reproducing part described above is disposed in a dead space in front of a radiator inside a front bumper. The reflection plate described above reflects a radiated sound of the speaker to converge to be able to pass through a narrow passage installed in the main body component of the vehicle and diffuse after being discharged to the outside of the vehicle through the narrow passage.

In addition, a second aspect of the present disclosure is a vehicle device including: a main body component; and a sound reproducing part that is disposed on an inner side of the main body component and radiates a sound to an outside of a vehicle.

### Advantageous Effects of Invention

According to the present disclosure, a vehicle-external sound reproducing device and a vehicle device reproducing a vehicle-external sound having added values while satisfying the requirements of the agreement regulations for the AVAS can be provided.

The effects described in the present specification are merely examples, and the effects provided by the present disclosure are not limited thereto. Further, the present disclosure may have additional effects, in addition to the effects described above.

Other objects, features, and advantages of the present disclosure will become clear from detailed descriptions based on embodiments described below and the attached drawings.

### BRIEF DESCRIPTION OF DRAWINGS

FIG. 1 is a diagram illustrating installation position candidates for an exciter on an inner wall of a front bumper.

FIG. 2 is a diagram illustrating a corresponding part of each installation position candidate on an outer wall of a front bumper.

FIG. 3 is a diagram illustrating a comparison result of frequency characteristics of a case in which an exciter is installed at each installation position candidate.

FIG. 4 is a diagram illustrating a comparison result of a sound pressure level of a case in which an exciter is installed at each installation position candidate.

FIG. 5 is a diagram illustrating a measurement result (100-300 Hz) of an acoustic intensity of a case in which an exciter is installed at a first installation position candidate.

FIG. 6 is a diagram illustrating a measurement result (300-500 Hz) of an acoustic intensity of a case in which an exciter is installed at the first installation position candidate.

FIG. 7 is a diagram illustrating a measurement result (500-700 Hz) of an acoustic intensity of a case in which an exciter is installed at the first installation position candidate.

FIG. 8 is a diagram illustrating a measurement result (700-1000 Hz) of an acoustic intensity of a case in which an exciter is installed at the first installation position candidate.

FIG. 9 is a diagram illustrating a measurement result (1000-3000 Hz) of an acoustic intensity of a case in which an exciter is installed at the first installation position candidate.

FIG. 10 is a diagram illustrating a measurement result (3000-5000 Hz) of an acoustic intensity of a case in which an exciter is installed at the first installation position candidate.

FIG. 11 is a diagram illustrating a measurement result (5000-10,000 Hz) of an acoustic intensity of a case in which an exciter is installed at the first installation position candidate.

FIG. 12 is a diagram illustrating installation position candidates of an exciter other than the front bumper.

FIG. 13 is a diagram illustrating a cross-section of a front bumper in which a plurality of exciters are installed with being aligned in a horizontal direction.

FIG. 14 is a diagram illustrating a functional configuration of a vehicle-external sound reproducing device 1400 (a first embodiment) combined with an in-vehicle sensor.

FIG. 15 is a diagram illustrating a view (a view seen from a vehicle front side) in which a vehicle-external sound reproducing device (a second embodiment) is disposed inside a front bumper.

FIG. 16 is a diagram illustrating a view in which a vehicle-external sound reproducing device (the second embodiment) is disposed inside a front bumper.

FIG. 17 is an enlarged diagram of a vehicle-external sound reproducing device (the second embodiment) of the inside of the front bumper.

FIG. 18 is a diagram illustrating a front face configuration of a speaker 1701.

FIG. 19 is a diagram illustrating the shape of a reflection surface of a reflection plate 1702.

FIG. 20 is diagram illustrating a simulation result based on an acoustic ray analysis of sound rays discharged from a high-frequency speaker 1802.

FIG. 21 is diagram illustrating a simulation result based on an acoustic ray analysis of sound rays discharged from the high-frequency speaker 1802.

FIG. 22 is diagram illustrating a simulation result based on an acoustic ray analysis of sound rays discharged from the high-frequency speaker 1802 from a top face.

FIG. 23 is diagram illustrating a simulation result based on an acoustic ray analysis of sound rays discharged from the high-frequency speaker 1802 from a side face.

FIG. 24 is diagram illustrating a simulation result based on an acoustic ray analysis of sound rays discharged from a low-frequency speaker 1801.

FIG. 25 is diagram illustrating a simulation result based on an acoustic ray analysis of sound rays discharged from a low-frequency speaker 1801.

FIG. 26 is diagram illustrating a simulation result based on an acoustic ray analysis of sound rays discharged from a low-frequency speaker 1801 from the top face.

FIG. 27 is diagram illustrating a simulation result based on an acoustic ray analysis of sound rays discharged from a low-frequency speaker 1801 from the side face.

FIG. 28 is a diagram illustrating a simulation result (a first resonance mode) of vibration of a reflection plate.

FIG. 29 is a diagram illustrating a simulation result (a second resonance mode) of vibration of a reflection plate.

FIG. 30 is a diagram illustrating a measurement result of a sound pressure level of a sound output from the vehicle-external sound reproducing device (the second embodiment).

FIG. 31 is a diagram illustrating a measurement result of the intensity of a radiated sound radiated from the vehicle-external sound reproducing device (the second embodiment).

FIG. 32 is a diagram illustrating a measurement result of the intensity of a radiated sound radiated from the vehicle-external sound reproducing device (the second embodiment).

FIG. 33 is a diagram illustrating a measurement result (a vehicle left front side) of a sound pressure level of a radiated sound radiated from the vehicle-external sound reproducing device (the second embodiment).

FIG. 34 is a diagram illustrating a measurement result (a vehicle right front side) of a sound pressure level of a radiated sound radiated from the vehicle-external sound reproducing device (the second embodiment).

FIG. 35 is a diagram illustrating a measurement result (a vehicle left rear side) of a sound pressure level of a radiated sound radiated from the vehicle-external sound reproducing device (the second embodiment).

FIG. 36 is a diagram illustrating a measurement result (a vehicle right rear side) of a sound pressure level of a radiated sound radiated from the vehicle-external sound reproducing device (the second embodiment).

FIG. 37 is a diagram illustrating a functional configuration of the vehicle-external sound reproducing device 3700 (the second embodiment).

FIG. 38 is a diagram illustrating a functional configuration of a vehicle-external sound reproducing device 3800 (the second embodiment).

FIG. 39 is a diagram (a perspective view) of an external configuration of an exciter.

FIG. 40 is a diagram (a top view and a side view) of an external configuration of an exciter.

FIG. 41 is a diagram illustrating a method of installing an exciter in a front bumper (a view in which a stand is fixed to an inner wall of the front bumper).

FIG. 42 is a diagram illustrating a method of installing an exciter in a front bumper (a view in which an exciter is fixed to an inner wall of the front bumper via the stand).

### DESCRIPTION OF EMBODIMENTS

The present disclosure will be described hereinafter in the following order, with reference to the drawings.
A. Overview
B. First Embodiment
B-1. Arrangement Of Exciter in Front Bumper
B-2. Comparison of Frequency Characteristics at Respective Installation Position Candidates
B-3. Other Installation Position Candidates
B-4. Application To Other Uses
B-5. Method of Installing Exciter
C. Second Embodiment
C-1. Configuration Example
C-2. Simulation Results
C-2-1. Simulation Results of Sound rays
C-2-2. Simulation Results of Reflection Plate
C-3. Measurement Results
C-4. Functional configuration
C-4-1. First Configuration Example
C-4-2. Second Configuration Example

### A. Overview

An AVAS is a vehicle approach notification device used for notification of the approach of a vehicle to pedestrians and the like in consideration of quietness of traveling sounds of electric vehicles. In R138 “Agreement Regulations relating to Quiet Vehicles”, for example, requirements for the AVAS as below are specified.

### (1) Regulation Target Vehicle Speed

Forward driving at 10 km/h and 20 km/h, and reverse driving are specified as regulation targets. However, there is no obligation of sound emission at the time of being stopped (0 km/hr), and there is no obligation of sound emission at a vehicle speed exceeding 20 km/h.

### (2) Sound Pressure

When driving at the regulation target vehicle speed described above, the A-weighted sound pressure level is measured using a microphone installed 2.0 m to a lateral side from a vehicle traveling center line and 1.2 m above the ground, and frequency analysis is performed, the measured sound pressure level is required to exceed an overall level and a level set for each ⅓-octave band. For the ⅓-octave band, the measured pressure level is required to exceed levels set in at least two bands, and at least one band thereof is required to be a band with a center frequency of 1.6 kHz or lower. The A-weighting is a frequency weighted characteristic with the sensitivity of human hearing taken into account, which are used for measurement using a noise meter, and is specified in JIS C 1502-1990 “General Sound Level Meter”.

### (3) Acceleration and Deceleration

A sound from an AVAS is required to change its frequency characteristics according to the speed. More specifically, at least one component sound among generated sounds is required to be shifted by 0.8% per 1 km/h on average in the speed range of 5 to 20 km/h.

### (4) Others

A temporary stop function of sounds of an AVAS is prohibited. For example, even if a driver determines that it is unnecessary to emit sound in the case of a residential area late at night, a congested expressway, or the like, the sound emission cannot be temporarily stopped. On the other hand, as long as the requirements described above are satisfied, it is allowed to have a function of selecting a sound tone and a sound pressure.

The present disclosure proposes a vehicle-external sound reproducing device that satisfies the requirements described above and is capable of reproducing a high value-added vehicle-external sound with a high sound quality that is sufficient for audio listening. Furthermore, the vehicle-external sound reproducing device according to the present disclosure can be applied to not only reproduction of a vehicle approach notification sound but also output of various vehicle-external sounds such as an answer-back sound and the like.

### B. First Embodiment

In this Section B, as a first embodiment of the present disclosure, a vehicle-external sound reproducing device that is configured by an exciter installed on the inner side of main body components of a vehicle and uses a part near an installation position of the main body components as a vibration plate will be described.

An exciter is a vibration plate drive unit that drives a vibration plate and converts an electrical signal into a sound by driving the vibration plate using an input electrical signal. A general exciter of a conduction type includes a voice coil to which an electrical signal is input and a magnetic circuit that is formed from a permanent magnet and a yoke generating a magnetic field around the voice coil. Generally, an exciter is installed inside a speaker box for outdoor or home music listening or is installed in a vehicle cabin of a vehicle and is used for acoustic reproduction of music or voices output from a radio or a car stereo device. For example, an in-vehicle speaker system using an exciter has been proposed (see PTL 2). In this embodiment, an exciter is applied to not acoustic reproduction inside a vehicle cabin but reproduction of vehicle-external sounds such as a warning sound of an AVAS and the like.

### B-1. Arrangement of Exciter in Front Bumper

Considering that the A-weighted sound pressure level measured by a microphone installed 2.0 m to the lateral side from the vehicle traveling center line and at a height of 1.2 m above the ground satisfies requirements (described above) of the R138 agreement regulations, the vehicle-external sound reproducing device according to this embodiment is configured to reproduce a vehicle-external sound by installing an exciter on an inner wall of the front bumper and using a part in which the front bumper is installed as a vibration plate.

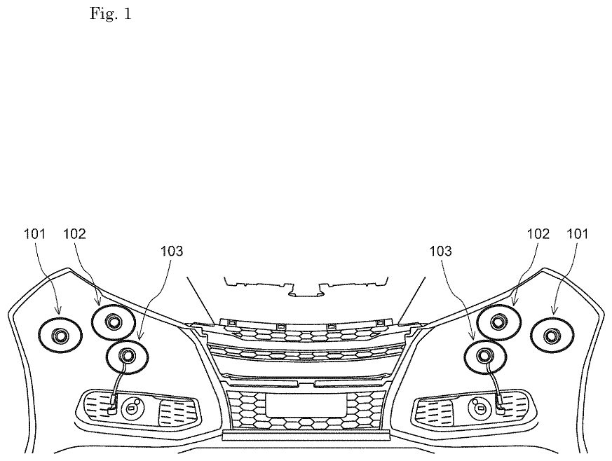

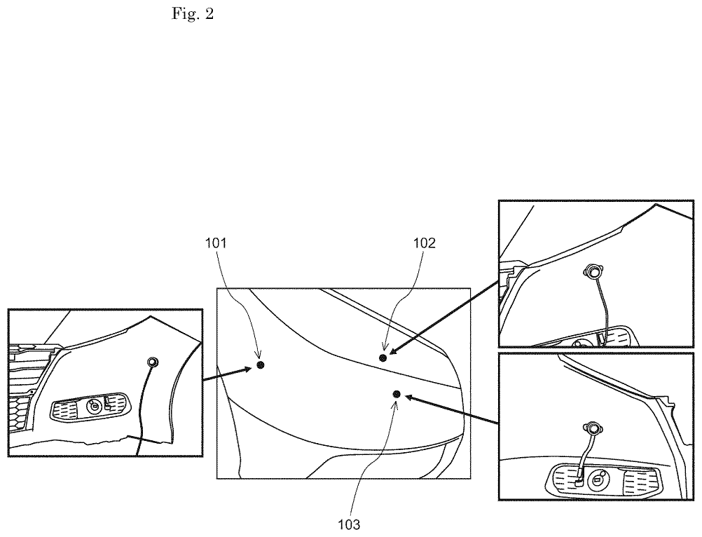

In FIG. 1, three positions 101 to 103 that are installation position candidates of an exciter on the inner wall of the front bumper are illustrated. In addition, in FIG. 2, parts corresponding to the installation position candidates 101 to 103 are illustrated on an outer wall of the front bumper. Since the A-weighted sound pressure level measured by a microphone installed 2.0 m to the lateral side from the vehicle traveling center line and at a height of 1.2 m above the ground satisfies the requirements, all the installation position candidates 101 to 103 are arranged near left and right ends of the front bumper. More specifically, the first installation position candidate 101 is arranged at a part close to left and right side faces that are on slightly outer sides than a bending part of the front bumper. In addition, the second installation position candidate 102 is arranged at a part close to left and right bending parts on the front face of the front bumper, and the third installation position candidate 103 is arranged at a part close to a slightly center side on the front face of the front bumper.

In FIG. 1, a view in which an exciter is arranged at a part of each of the installation position candidates 101 to 103 on the inner wall of the front bumper is illustrated. The exciter has an outer shape of a cylinder shape, has an acoustic output unit configured using a coil, a yoke, a magnet, and the like arranged inside, and reproduces a vehicle-external sound diffusing toward the outside of the vehicle by vibrating a part near an installation position of the front bumper by vibrating in an axial direction.

### B-2. Comparison of Frequency Characteristics at Respective Installation Position Candidates

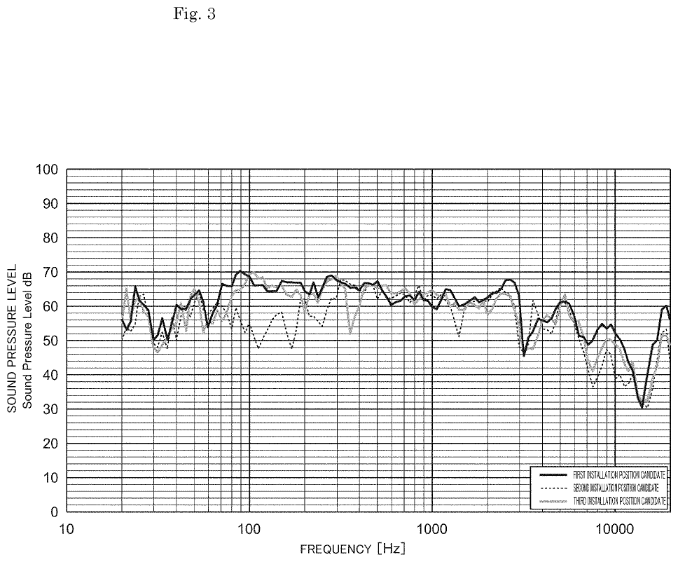

In FIG. 3, frequency characteristics measured in a case in which an exciter is installed at each of the installation position candidates 101 to 103 illustrated in FIGS. 1 and 2 are illustrated. Here, the horizontal axis represents a frequency axis (Hz), and the vertical axis represents a sound pressure level (dB). A measurement result of a case in which an exciter is installed at the first installation position candidate 101 is denoted by a black solid line, a measurement result of a case in which an exciter is installed at the second installation position candidate 102 is denoted by a black and thin broken line, and a measurement result of a case in which an exciter is installed at the third installation position candidate 103 is denoted by a gray solid line.

There is no big difference between frequency characteristics of the installation position candidate 101 and the installation position candidate 103. Since the first installation position candidates 101 are arranged at parts close to left and right side faces on an outer side of the bending part of the front bumper, sounds tend to spread to the lateral side. On the other hand, since the third installation position candidates 103 are arranged at parts close to a slightly center side on the front face of the front bumper, sounds tend to output to the front side.

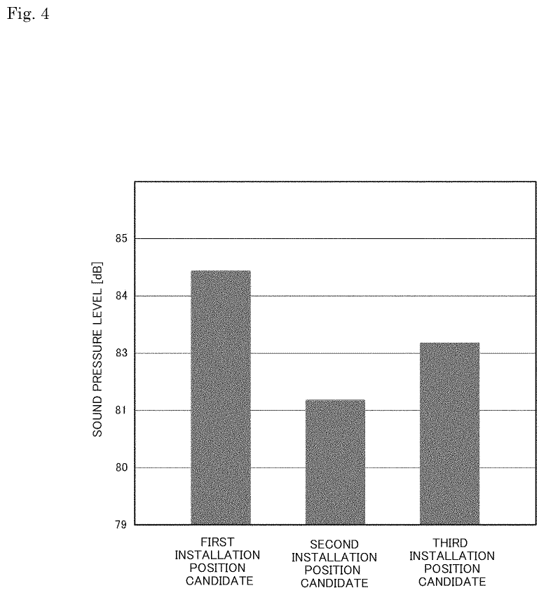

In FIG. 4, a comparison result of sound pressure levels of a case in which an exciter is installed at each of the installation position candidates 101 to 103 is illustrated. At the first installation position candidate 101 and the third installation position candidate 103 that are relative flat parts of the front bumper, a high sound pressure level can be obtained. In contrast to this, at the second installation position candidate 102 that is close to the bending part of the front bumper, a sound pressure level becomes low.

When the comparison results of frequency characteristics and sound pressure levels illustrated in FIGS. 3 and 4 are reviewed, a conclusion indicating that the first installation position candidate 101 is more appropriate as an installation position of an exciter is reached. In a case in which an exciter is installed at the first installation position candidate 101 of the front bumper, by using this position of the front bumper as a vibration plate, a sound of a higher sound pressure level can be broadly delivered to a side of the vehicle. Hereinafter, exciters will be described to be installed at the first installation position candidates 101, which has horizontal symmetry, of the inner wall of the front bumper.

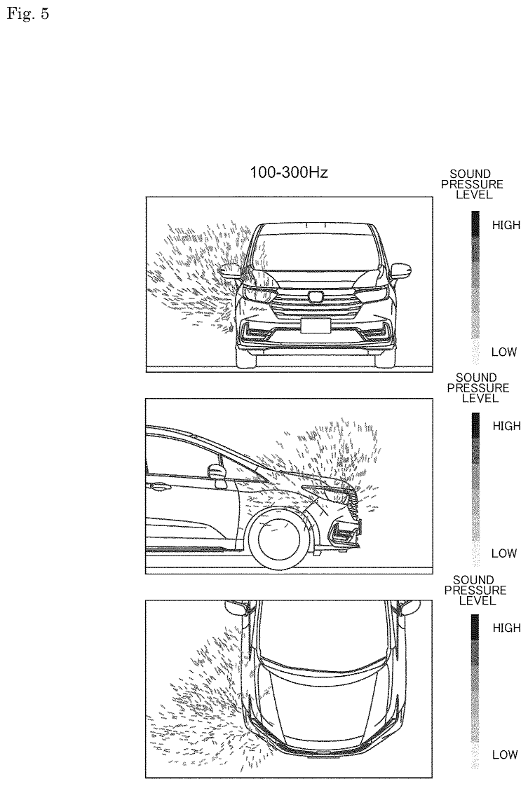

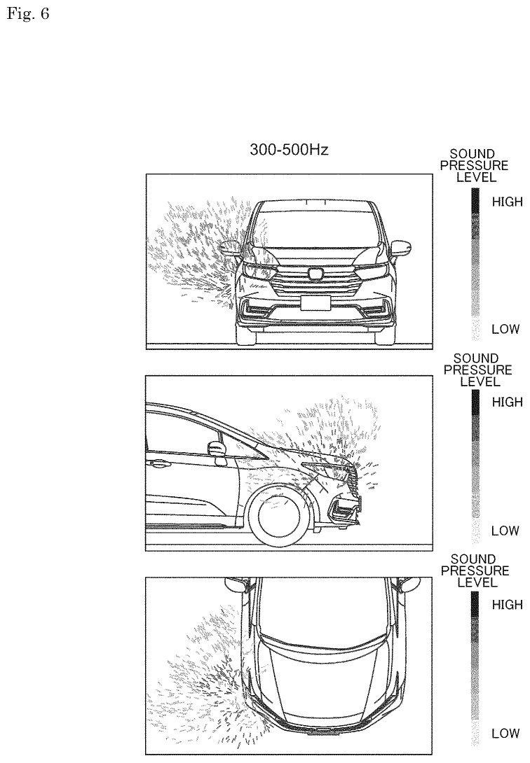

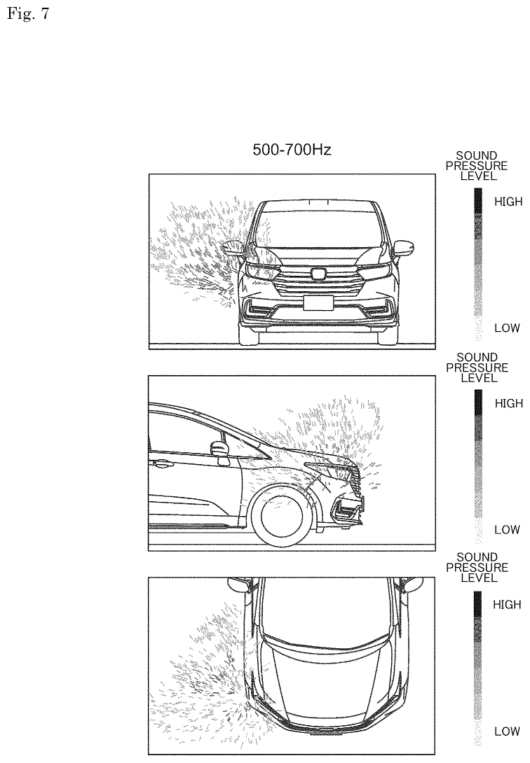

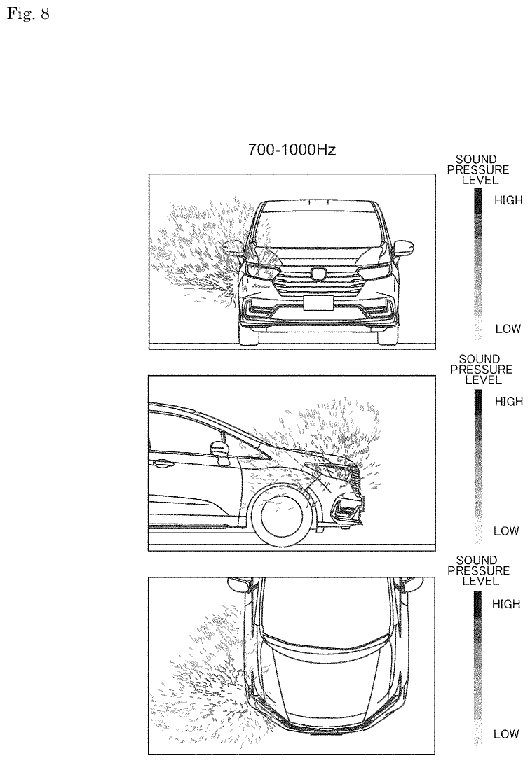

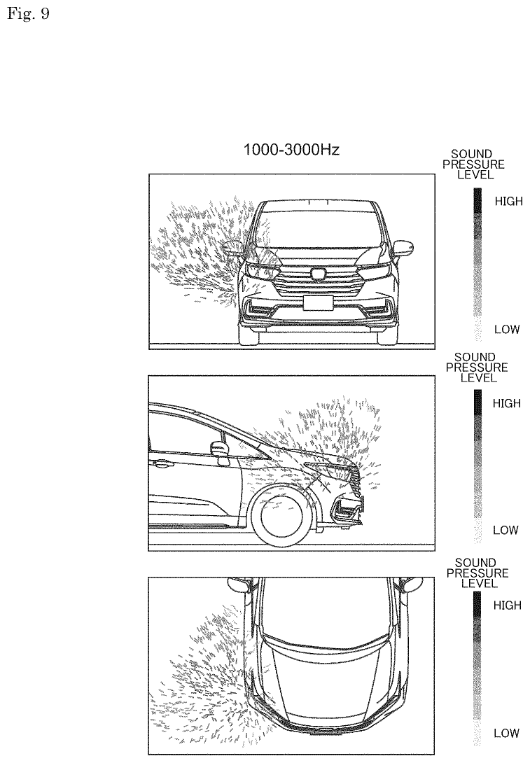

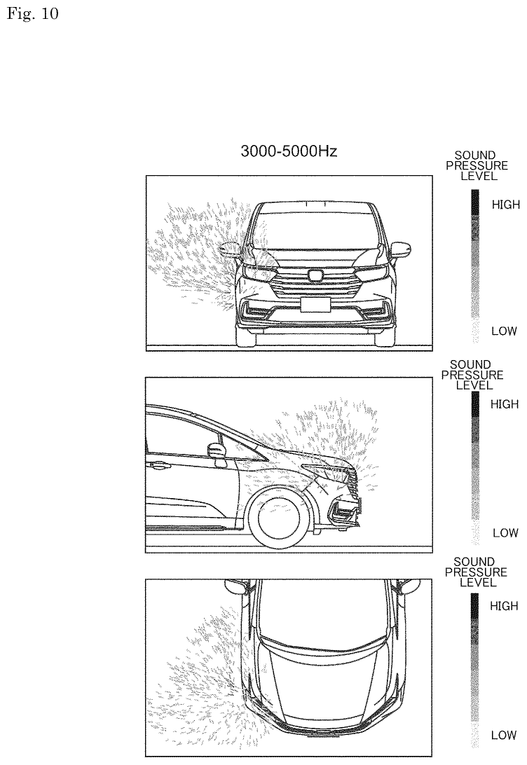

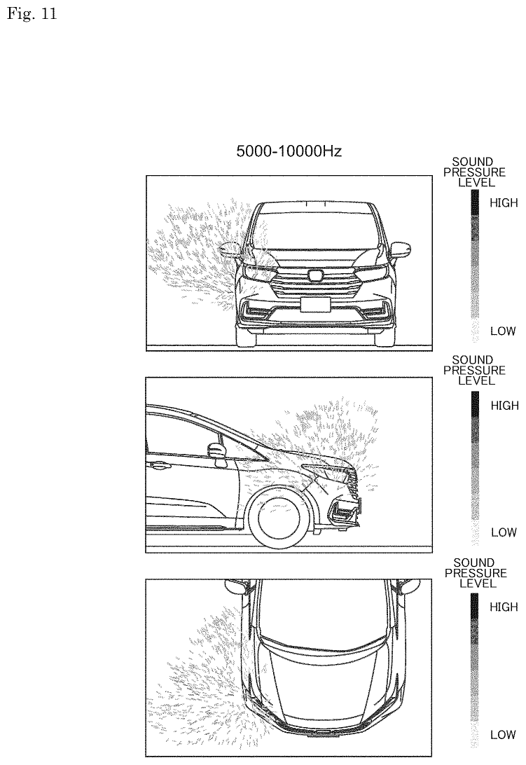

FIGS. 5 to 11 illustrate measurement results of acoustic intensity for each frequency band that are acquired in a case in which exciters are installed at the first installation position candidates 101. FIGS. 5, 6, 7, 8, 9, 10, and 11 are measurement results of acoustic intensities in respective frequency bands of 100-300 Hz, 300-500 Hz, 500-700 Hz, 700-1000 Hz, 1000-3000 Hz, 3000-5000 Hz, and 5000-10000 Hz. From FIGS. 5 to 11, it can be understood that, when exciters installed at the first installation position candidates 101 vibrate these positions of the front bumper, a sound with a sound pressure level satisfying the requirements of the agreement regulations for an AVAS is radiated near a microphone position (2.0 m to the lateral side from the vehicle traveling center line and at 1.2 m height above the ground) in measurement of the R138 agreement regulations in each frequency band.

A vehicle-external sound reproducing device configured by installing exciters at the first installation position candidates 101 of the front bumper has sufficient acoustic intensity in each frequency band and thus can be regarded as being able to reproduce a diverse range of sounds.

### B-3. Other Installation Position Candidates

In Section B-1 and Section B-2 described above, the vehicle-external sound reproducing device having a configuration in which the exciters are installed in the front bumper has been described. In addition, although the exciters are directly installed in a main body component of the vehicle other than the front bumper, similarly, a sound with high sound quality satisfying the requirements of the high sound pressure level and the frequency characteristics can be reproduced at a position (2.0 m to the lateral side from the vehicle traveling center line and at the 1.2 m height above the ground) specified in the R138 agreement regulations.

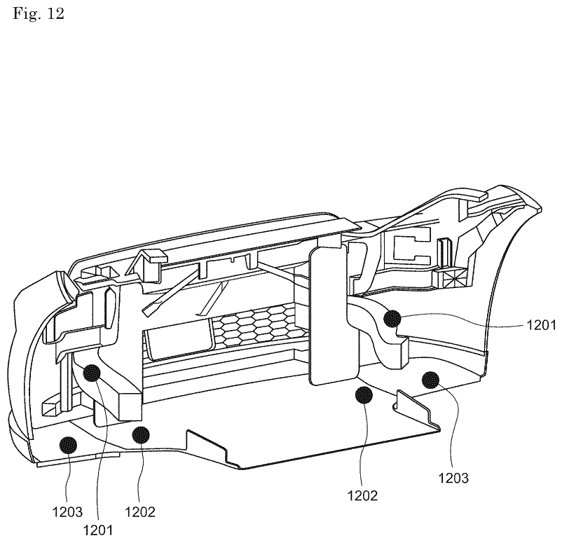

FIG. 12 illustrates installation position candidates of exciters on a vehicle front side other than the front bumper. In the drawing, Reference Numeral 1201 represents installation position candidates set in air intake ducts, and Reference Numerals 1202 and 1203 represent installation position candidates set in an undercover. It is apparent that, even when the exciters are installed in main body components of respective parts of a vehicle front side, a side face, a rear side, a ceiling, and a bottom face, which can function as vibration plates, other than the front bumper and the positions illustrated in FIG. 12, a vehicle-external sound reproducing device according to this embodiment can be configured.

### B-4. Application to Other Uses

By directly installing exciters in a main body component of a vehicle such as a front bumper or the like and using the main body component as a vibration plate, the vehicle-external sound reproducing device according to this embodiment sufficiently satisfies the sound pressure and the characteristics at a position specified in the R138 agreement regulations as described in Section B-2 described above. According to the configuration in which exciters are directly installed, and the main body component is used as a vibration plate, a sound with high sound quality can be generated, and thus the sound quality of a notification sound of the AVAS can be improved, and, furthermore, an iconic sound (distinctive and allows easy understanding of a content to be delivered) can be reproduced.

The use of the vehicle-external sound reproducing device according to this embodiment is not limited to the output of a notification sound of an AVAS. The vehicle-external sound reproducing device according to this embodiment is not limited to a target vehicle speed, particularly, regulated by the R138 agreement regulations and, for example, can be used for reproducing a vehicle-external sound for newly alerting surrounding pedestrians also at the time of low-speed traveling and at the time of high-speed traveling that are non-regulation targets. In addition, the vehicle-external sound reproducing device according to this embodiment can be used together for an answer-back sound.

By installing two or more exciters in a main body component of a vehicle to enable a stereo sound, they may be used for reproduction of a notification sound of an AVAS and other acoustic reproduction. In Section B-1 and Section B-2, positions close to side faces that are on slightly outer sides of the bending part of the front bumper have been described as optimal exciter installation positions. Furthermore, by installing exciters at two or more places of the front bumper (or a vehicle main body component other than the front bumper) including these installation positions to enable a stereo sound, a notification sound of an AVAS and an answer-back sound can be reproduced with a wide range of acoustic effects.

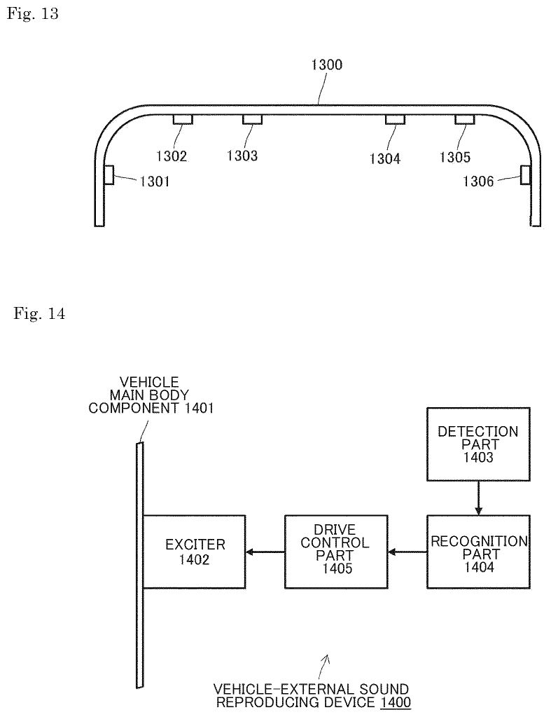

FIG. 13 is a diagram illustrating an example of a cross-section view of the front bumper 1300 in which a plurality of exciters 1301, 1302, . . . are installed with being aligned in a horizontal direction. Since the installation parts of the exciters 1301, 1302, . . . operate as vibration plates, the front bumper 1300 functions as a line array speaker in which a plurality of speaker units are aligned in the horizontal direction. Thus, a vehicle-external sound reproducing device formed from the front bumper 1300 in which the plurality of exciters 1301, 1302, . . . are installed improves the sound pressure level of a reproduced sound and can deliver a clear and uniform sound source in an intended direction through beam control.

As described in Section B-2 described above, the vehicle-external sound reproducing device according to this embodiment has a sufficient acoustic intensity in each frequency band and thus can reproduce a diverse range of high-quality sounds. Thus, the vehicle-external sound reproducing device according to this embodiment can reproduce sounds with different sound tones and different melodies in accordance with various uses such as answer back and the like other than at the output of a notification sound of an AVAS. For example, the sound tone or melody of a vehicle approach notification sound may be switched between a case in which the vehicle moves forward and a case in which the vehicle moves backward. In addition, for an application to an answer-back function, for example, the sound tone or melody of a reproduced sound may be finely switched when the door is locked and when the door is unlocked. In such a case, a listener can identify whether a vehicle-external sound being emitted now indicates one of a notification of vehicle approach and answer-back (door locking or unlocking).

For example, in combination with an in-vehicle sensor mounted in the vehicle, the vehicle-external sound reproducing device according to this embodiment can be simultaneously used for a plurality of uses. FIG. 14 schematically illustrates a functional configuration of a vehicle-external sound reproducing device 1400 combined with an in-vehicle sensor.

The illustrated vehicle-external sound reproducing device 1400 includes an exciter 1402, a detection part 1403, a recognition part 1404, and a drive control part 1405.

The exciter 1402 is directly installed in a main body component 1401 of a vehicle. Although the main body component 1401 of the vehicle is representatively a front bumper, it may be any other vehicle main body component such as an air intake duct, an undercover, a rear bumper, or the like. In addition, at least one exciter 1402 is installed in the main body component 1401, and, as described above, it is more preferably in the form of a stereo speaker, a line speaker array, or the like in which two or more exciters are installed in the main body component 1401.

The detection part 1403 is formed from an in-vehicle sensor or the like. The in-vehicle sensor includes an external recognition sensor, a vehicle internal sensor, and a vehicle sensor. The detection part 1403 may use some of in-vehicle sensors equipped in a vehicle control system.

The external recognition sensor is formed from one or more sensors used for recognition of external situations (nearby pedestrians, preceding vehicles, following vehicles, and the like) of the vehicle and includes a camera, a radar, a Light Detection and Ranging (Laser Imaging Detection and Ranging (LiDAR)), an ultrasonic sensor, and the like. In addition, the external recognition sensor may further include an environment sensor (a rain sensor, a fog sensor, a sunlight sensor, a snow sensor, an illuminance sensor, or the like) detecting the surrounding environment of the vehicle and a microphone receiving surrounding sounds of the vehicle.

The vehicle internal sensor is a camera, a radar, a seat occupancy sensor, a steering wheel sensor, a microphone, a biometric sensor, and the like installed to have the inside of the vehicle as a detection range. The vehicle sensor is formed from one or more sensors detecting the state of the vehicle. In a case in which the internal situation of the vehicle does not need to be perceived for vehicle-external sound reproducing control, the vehicle internal sensor is unnecessary.

The vehicle sensor may include a speed sensor, an acceleration sensor, an angular velocity sensor (gyro sensor), or an Inertial Measurement Unit (IMU) integrating these, a steering angle sensor that detects the steering wheel's steering angle, a yaw rate sensor, an accelerator sensor that detects the operation amount of an accelerator pedal, a brake sensor that detects the operation amount of a brake pedal, a rotation sensor that detects the rotational speed of an engine or a motor, a tire pressure sensor that detects the air pressure of tires, a slip ratio sensor that detects the slip ratio of tires, a wheel speed sensor that detects the rotational speed of wheels, a battery sensor that detects the remaining amount and the temperature of the battery, an impact sensor that detects an impact from the outside, and the like.

The recognition part 1404 recognizes events occurring in the vehicle on the basis of a detection signal acquired by the detection part 1403. The recognition part 1404 may perform a recognition process using, for example, a machine learning model learned to estimate events on the vehicle on the basis of detection signals through deep learning.

Events occurring in the vehicle are diverse. However, in this embodiment, the recognition part 1404 is assumed to recognize at least events for which a vehicle-external sound needs to be output. More specifically, events for which a vehicle-external sound needs to be output include an occurrence of an event for which an AVAS notification sound needs to be generated such as the vehicle reaching a regulated target speed specified by the R138 agreement regulations, an occurrence of an event for which a warning sound other than the AVAS needs to be generated according to an approach of a pedestrian regardless of the vehicle speed, an occurrence of an event such as door locking or unlocking for which an answer-back needs to be notified, and the like.

The drive control part 1405 controls the drive of the exciters 1402 to generate vehicle-external sounds formed from a volume, a sound tone, a melody, an advancement direction, and the like that are appropriate for an event recognized by the recognition part 1404.

Although a sound source of the vehicle-external sound reproducing device 1400 is the exciter 1402 that is directly installed in the main body component 1401 of the vehicle, as described above, a diverse range of high-quality sounds can be reproduced. Therefore, the vehicle-external sound reproducing device 1400 can reproduce sounds with different sound tones and melodies according to various uses such as answer-back and the like in addition to outputting of a notification sound of an AVAS. For example, the sound tone or the melody of a vehicle approach notification sound may be switched between a case in which the vehicle is moving forward and a case in which the vehicle is moving backward. In addition, in an application to an answer-back function, the sound tone or melody of the reproduced sound may be finely switched, for example, between when the doors are locked and when the doors are unlocked.

### B-5. Method of Installing Exciter

The vehicle-external sound reproducing device according to this embodiment is configured to install exciters on the inner side of a vehicle main body component such as an inner wall of the front bumper or the like and use a part near an installed position of the main body component as a vibration plate. To efficiently transmit vibrations of the exciters without any loss, it is necessary to install them in the main body component. Typically, the inner wall of the front bumper is formed as a curved face. Thus, in this embodiment, an installing method in which, after a flat structure is formed on the inner wall of the front bumper near the installing position of exciter, the exciter is fixed onto this flat surface is used. It is apparent that any other installing method may be used, as long as the exciters are installed such that vibrations of the exciters can be efficiently transmitted without any loss.

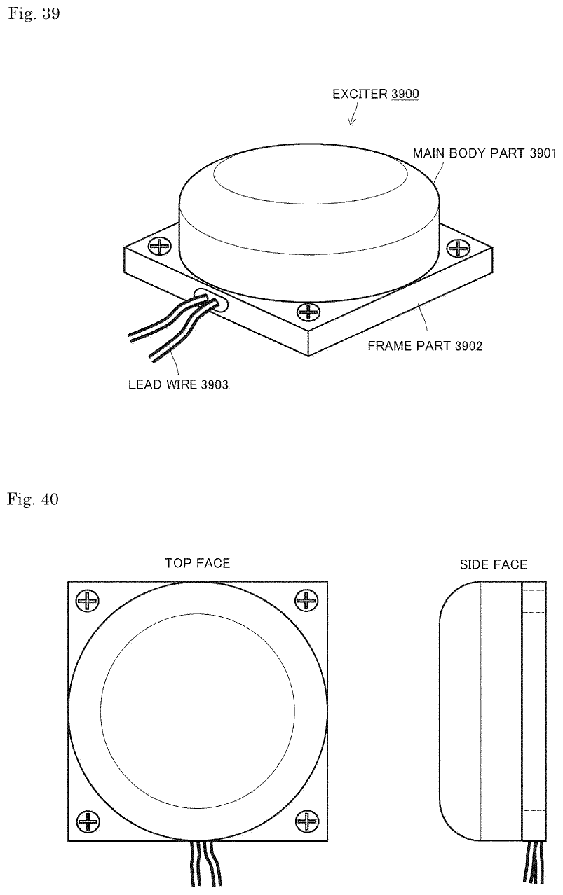

FIGS. 39 and 40 illustrate an external configuration of the exciter. FIG. 39 is a perspective view of the exciter 3900 from above, and FIG. 40 illustrates a top view and a side view of the exciter 3900. The illustrated exciter 3900 includes a main body part 3901 that generates vibrations that form the base of a reproduced sound and a frame part 3902 that protrudes outward from the bottom of the main body part 3901.

The main body part 3901 is formed in a cylindrical shape as its outer shape. Inside the main body part 3901, a voice coil to which an electrical signal is input and a magnetic circuit formed from a permanent magnet and a yoke that generate a magnetic field around the voice coil are installed, and vibrations are generated in the axial direction of the cylinder in accordance with an input electrical signal.

The frame part 3902 is a protrusion that protrudes from near the bottom face of the main body part 3901 in a flange shape and is formed in a rectangular flat plate shape. A lead wire 3903 used for inputting an electrical signal is connected to one side face of the flange part 3902. At four corners of the frame part 3902, screw holes for inserting and passing fixing screws (m4 screws) are formed.

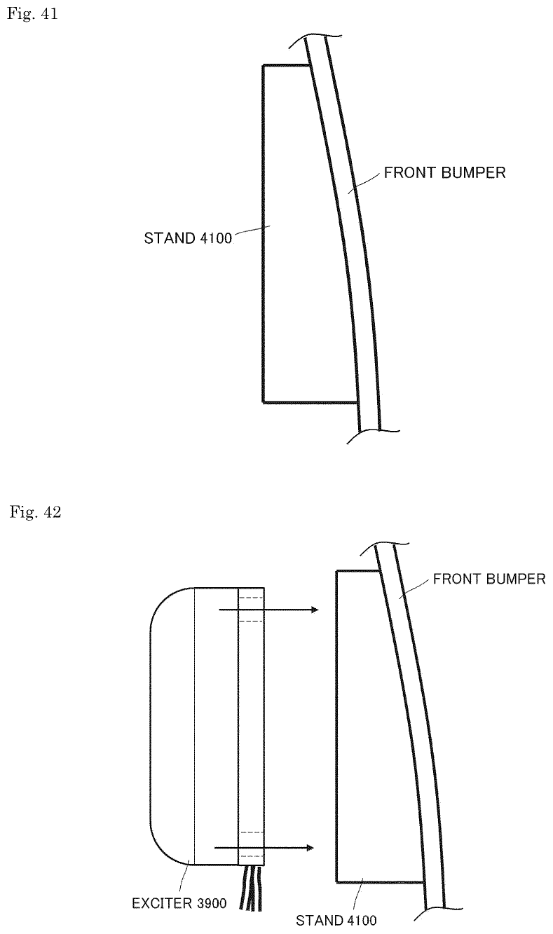

Vibrations generated by the main body part 3901 are output to the outside through the frame part 3902. For this reason, it is necessary to install the flat plate-shaped frame part 3902 to be in close contact with a main body component serving as a vibrating plate. A method of installing the exciters 3900 on the inner wall of the front bumper will be described with reference to FIGS. 41 and 42.

The inner wall of the front bumper is formed as a curved face. For this reason, a flat structure to serve as an installing surface of the exciters 3900 is formed near the installation position of the exciters on the inner wall of the front bumper. More specifically, as illustrated in FIG. 41, a stand 4100 of which a top face has a flat shape corresponding to the installation face of the exciters 3900 and of which a bottom face has a shape conforming to the inner wall of the front bumper is fixed to the inner wall of the front bumper. The stand 4100 can be manufactured using a 3D printer on the basis of 3D shape data of the inner wall of the front bumper. It is apparent that the stand may be manufactured using a processing method other than the method using the 3D printer. Then, the manufactured stand 4100 is bonded to an appropriate position on the inner wall of the front bumper using a panel bond or the like.

In addition, as illustrated in FIG. 42, the exciter 3900 is installed on the flat installation face of the stand 4100 on the inner wall of the front bumper. By fastening the four corners of the frame part 3902 to the installation face with screws, the exciter 3900 can be fixed to the inner wall of the front bumper. Thereafter, the exciter 3900 can reproduce a vehicle-external sound radiated outside the vehicle by vibrating the front bumper as a vibrating plate. However, in a case in which a flat face corresponding to the installation face of the exciter 3900 is formed in a shape integrated with the inner wall of the front bumper, the stand 4100 becomes unnecessary.

### C. Second Embodiment

In this Section C, as a second embodiment of the present disclosure, a vehicle-external sound reproducing device including a speaker used for reproducing a vehicle-external sound that is disposed inside a front bumper of a vehicle and a path changing unit that changes a path such that a sound from this speaker is discharged to the outside of the vehicle will be described. More specifically, the path changing unit is formed from a reflection plate that reflects a sound. The reflection plate has such an appropriate shape for reflecting a sound from the speaker that the sound converges to pass through a narrow passage such as an air intake or the like and then diffuses after being discharged to the outside of the vehicle through the narrow passage.

The speaker for reproducing a notification sound of an AVAS is installed outside the vehicle cabin and thus needs a waterproof function. A conventional speaker for reproducing a notification sound is configured only for the purpose of a warning, and thus the reproduction range is 100 to 5000 Hz which is not wide that much, and the sound quality is not that good. In contrast to this, the vehicle-external sound reproducing device according to this embodiment is configured such that a waterproof speaker unit is disposed utilizing a dead space in front of a radiator of the vehicle, and a high-quality sound that is suitable for audio listening with a wide range of 50 to 20000 Hz is discharged to the outside of the vehicle via a narrow passage using a reflection plate having an appropriate shape.

### C-1. Configuration Example

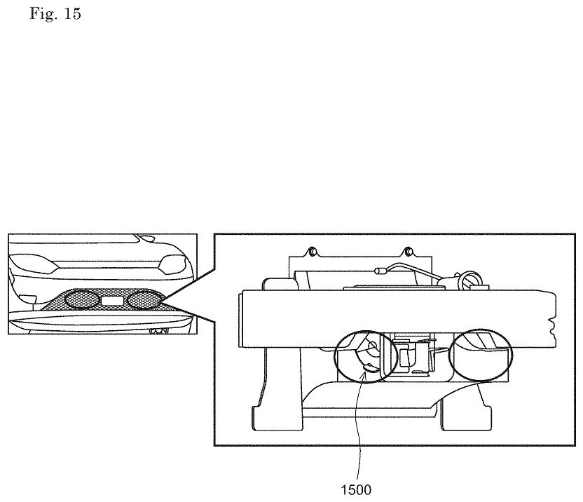

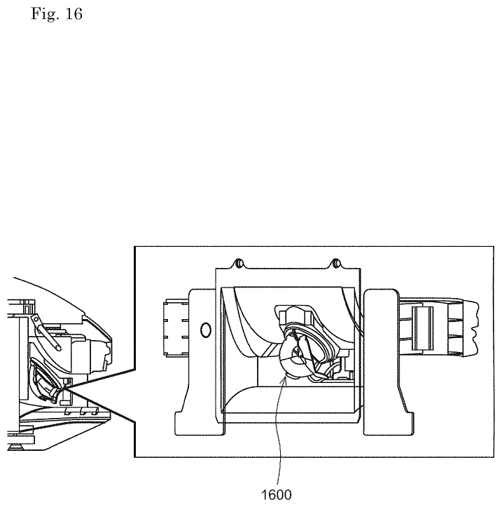

FIGS. 15 and 16 illustrate a view of the vehicle-external sound reproducing device according to this embodiment being disposed in a dead space in front of a radiator inside a front bumper. FIG. 15 illustrates a view of the vehicle-external sound reproducing device 1500 seen from the front side of the vehicle (the outside of the vehicle). Actually, since the vehicle-external sound reproducing device 1500 is disposed on a rear side near a license plate, it is difficult to observe it from the front side of the vehicle. FIG. 16 illustrates a view of the vehicle-external sound reproducing device 1600 seen from the inside of the front bumper. In addition, FIG. 17 illustrates the vehicle-external sound reproducing device disposed near the rear side of a license plate inside a front bumper in an enlarged scale.

A radar device and the like (not shown) are disposed on the front face of the vehicle, and when a speaker is installed with facing forward, a sound from the speaker is trapped inside the front bumper, and thus it becomes difficult to satisfy the requirements of a sound pressure level at a position (2.0 m to the lateral side from a vehicle traveling center line and at 1.2 m height above the ground) specified in the R138 agreement regulations. Thus, as illustrated in FIGS. 16 and 17, the vehicle-external sound reproducing device 1700 (or 1600) has a configuration in which the directivity of a sound can be controlled by disposing the speaker 1701 to face the rear side (that is, directing the radiation direction of a sound toward the rear side) and disposing the front side of the speaker 1701 (the radiation direction of a sound) on the reflection plate 1702. The reflection plate 1702 has such an appropriate shape for reflecting a sound from the speaker such that the sound converges to be able to pass through a narrow passage such as an air intake and the like and then diffuses after being discharged to the outside of the vehicle through the narrow passage.

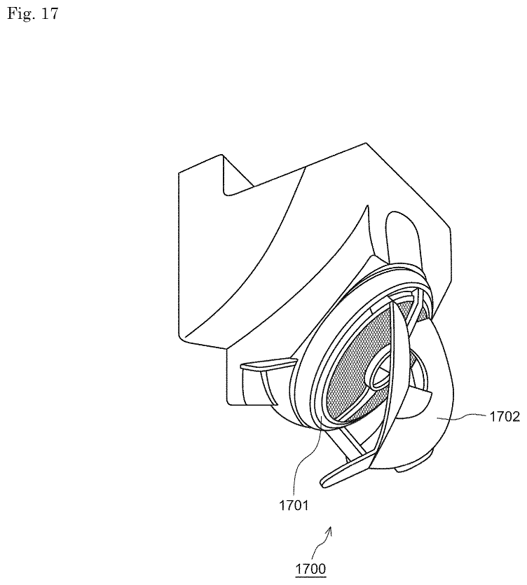

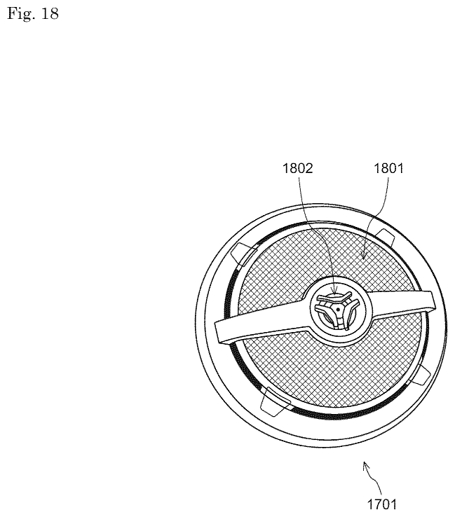

FIG. 18 illustrates a front face configuration of the speaker 1701. The speaker 1701 is an axial-type (coaxial-type) speaker device in which a plurality of speakers covering mutually-different sound frequency ranges are coaxially disposed, and a high-frequency (Tweeter) speaker 1802 is installed on the front side of a center pole of a low-frequency (Woofer) speaker 1801. Such a speaker device can perform high-quality reproduction across a wide frequency range from a low-frequency band to a high-frequency band and can radiate a sound emitted from the speaker covering each frequency band from an approximate center of the low-frequency speaker. Such a coaxial speaker device can be configured to be compact as a whole and thus is widely used as an in-vehicle speaker device (for example, see PTL 3). In addition, considering that the speaker 1701 is installed outside the vehicle, it is preferable that the speaker be a waterproof speaker unit with a waterproof function.

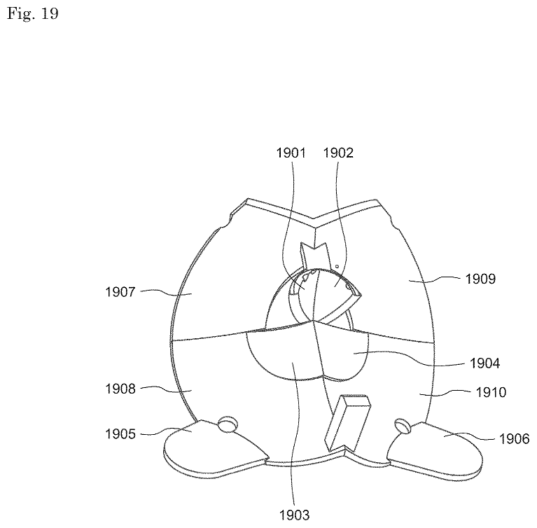

FIG. 19 illustrates an external view of the reflection plate 1702 disposed on the front face of the speaker 1701. FIG. 19 illustrates the shape of the surface of the reflection plate 1702, that is, a reflective surface reflecting a radiated sound from the speaker 1701 seen from the speaker 1701 side (that is, an opposite side from that of the example illustrated in FIGS. 16 and 17). The reflection plate 1702 controls the directivity by reflecting a radiated sound from the speaker 1701 to temporarily converge to be able to pass through a narrow passage such as an air intake and the like and to diffuse after being discharged to the outside of the vehicle through the narrow passage.

In correspondence with the speaker 1701 being configured by the low-frequency speaker 1801 and the high-frequency speaker 1802 of a coaxial form, the reflection plate 1702 includes a reflective surface reflecting a radiated sound from the low-frequency speaker 1801 and a reflective surface reflecting a radiated sound from the high-frequency speaker 1802.

The reflection plate 1702 has a first reflection part 1901, a second reflection part 1902, a third reflection part 1903, a fourth reflection part 1904, a fifth reflection part 1905, and a sixth reflection part 1906 as reflective surfaces for the high-frequency speaker 1802.

The first reflection part 1901 and the second reflection part 1902 have horizontally-symmetrical concave face-shaped reflective surfaces. The first reflection part 1901 and the second reflection part 1902 reflect high-frequency sound waves directly received from the high-frequency speaker 1802 and respectively generates parallel waves directed toward the fifth reflection part 1905 and the sixth reflection part 1906. The concave faces described here are realized by appropriate parabolic curved surfaces such that sound rays diverging from the center of the sound source of the high-frequency speaker 1802 converge into parallel waves through reflection. The fifth reflection part 1905 and the sixth reflection part 1906 have horizontally-symmetrical convex face-shaped reflective surfaces and further reflect the parallel waves received from the first reflection part 1901 and the second reflection part 1902 to narrow passage sides (the air intakes on the left and right sides) connected to the outside of the vehicle and generate diffusion waves diffusing after being discharged to the outside of the vehicle through the narrow passages in two stages. By reflecting sound rays in two stages in this way, the reflective surfaces can be configured to be small.

The third reflection part 1903 and the fourth reflection part 1904 have horizontally-symmetrical concave face-shaped reflective surfaces. The concave faces described here are realized by appropriate parabolic curved surfaces to which an appropriate aperture ratio is applied such that sound rays diverging from the center of the sound source of the high-frequency speaker 1802 are directly reflected to narrow passage sides (air intakes on left and right sides) and can diffuse outside of the vehicle after passing through the narrow passages. The third reflection part 1903 and the fourth reflection part 1904 reflect high-frequency sound waves directly received from the high-frequency speaker 1802 to narrow passage sides (the air intakes on the left and right sides) connected to the outside of the vehicle and generate diffusion waves diffusing after being discharged to the outside of the vehicle through the narrow passages in one stage.

In addition, the reflection plate 1702 has a seventh reflection part 1907, an eighth reflection part 1908, a ninth reflection part 1909, and a tenth reflection part 1910 as reflective surfaces for the low-frequency speaker 1801. All the seventh reflection part 1907, the eighth reflection part 1908, the ninth reflection part 1909, and the tenth reflection part 1910 have concave face-shaped reflective surfaces and are respectively disposed on outer sides of the first reflection part 1901, the third reflection part 1903, the second reflection part 1902, and the fourth reflection part 1904. The concave faces described here are realized by appropriate parabolic curved surfaces to which an appropriate aperture ratio is applied such that sound rays diverging from the center of the sound source of the low-frequency speaker 1801 are reflected to narrow passage sides (air intakes on the left and right sides) and can diffuse outside of the vehicle after passing through the narrow passages. Thus, the seventh reflection part 1907, the eighth reflection part 1908, the ninth reflection part 1909, and the tenth reflection part 1910 reflect low-frequency sound waves directly received from the low-frequency speaker 1801 to narrow passage sides (the air intakes on the left and right sides) connected to the outside of the vehicle and generate diffusion waves diffusing after being discharged to the outside of the vehicle through the narrow passages in one stage. The fifth reflection part 1905 and the sixth reflection part 1906 used in second-stage reflection of sound waves of high-frequency sound waves are respectively disposed on outer sides of the eighth reflection part 1908 and the tenth reflection part 1910.

The purpose of the reflection plate 1702 is for controlling directivity such that sound waves from the low-frequency speaker 1801 and the high-frequency speaker 1802 pass through narrow passages (air intakes on the left and right sides) and are converted into diffusion waves discharged to the front side of the vehicle. By introducing a structure reflecting sound waves in two stages and the like, the reflective surfaces are provided to be small, and the reflection plate 1702 can be formed to be compact. Thus, air can be efficiently sent to a radiator (not shown) of the rear side without the reflection plate 1702 interfering with air flowing into the inside of the vehicle from the air intakes. The shape of the reflection plate 1702 illustrated in FIG. 19 is one example and may be another shape as long as directivity control of a radiated sound from the speaker 1701 can be similarly realized.

There is a risk of stones and the like on a road surface entering the inside of the front bumper. In addition, the vehicle-external sound reproducing device according to this embodiment has a structure in which a sound from the speaker 1701 is reflected by the reflection plate 1702 and is radiated to the outside of the vehicle. When the reflection plate 1702 is deformed due to acoustic resonance, the reflection direction deviates from the narrow passage (the air intake), and a reflected sound cannot be radiated to the outside of the vehicle, whereby the sound pressure and the sound quality deteriorate. For this reason, the vehicle-external sound reproducing device according to this embodiment needs to have a sufficiently high mechanical strength and suppress acoustic resonance. Details of this point will be described below (Section C-2-2 represented below). In addition, by using a reflected sound, a configuration in which the speaker 1701 is disposed to face the rear side is employed, and thus the risk of the speaker 1701 being damaged by being directly hit by a stone and the like entering the inside of the front bumper can be significantly reduced.

### C-2. Simulation Results

In this Section C-2, the performance of the vehicle-external sound reproducing device according to this embodiment described in Section C-1 described above will be reviewed on the basis of simulations.

### C-2-1. Acoustic Simulation Results

First, in Section C-2-1, results of simulations of sound rays discharged from each of the high-frequency speaker 1802 and the low-frequency speaker 1801 in the vehicle-external sound reproducing device in which the speaker 1701 and the reflection plate 1702 have the configurations illustrated in FIGS. 18 and 19 based on an acoustic ray analysis will be described.

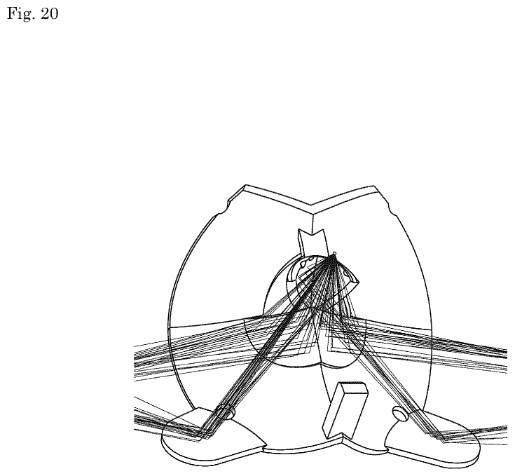

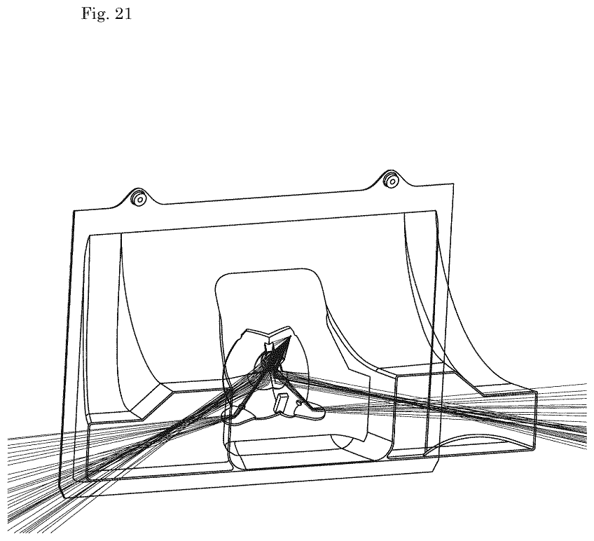

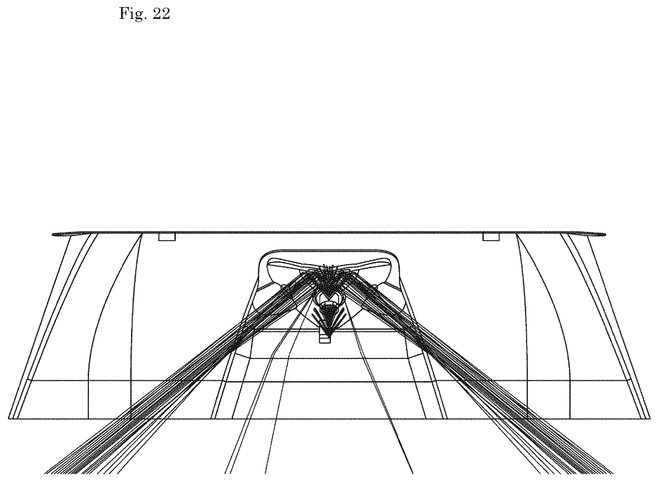

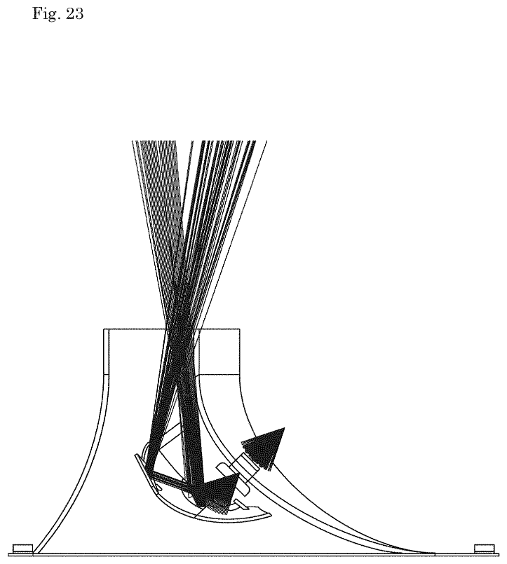

FIGS. 20 to 23 illustrate simulation results based on a sound ray analysis of sound rays discharged from the high-frequency speaker 1802. In the drawings, a plurality of sound rays discharged from the high-frequency speaker 1802 and traveling directions of sound rays after being reflected by the reflection plate 1702, which are acquired through a sound ray simulation, are drawn. Here, FIG. 20 illustrates a view in which sound rays discharged from the high-frequency speaker 1802 are reflected by the reflection parts 1901 to 1906 of the reflection plate 1702 in an enlarged scale. FIGS. 21 to 23 illustrate behaviors of sound rays discharged from the high-frequency speaker 1802 inside a front bumper. FIG. 21 illustrates a perspective view of the reflection plate 1702 from the front side, FIG. 22 illustrates a view of the reflection plate 1702 viewed from an upper side, and FIG. 23 illustrates a view of the reflection plate 1702 viewed from a lateral side.

As can be understood from FIGS. 20 to 23, the first reflection part 1901 and the second reflection part 1902 reflect high-frequency sound waves directly received from the high-frequency speaker 1802 and generate parallel waves directed toward the fifth reflection part 1905 and the sixth reflection part 1906. The fifth reflection part 1905 and the sixth reflection part 1906 have horizontally-symmetrical convex face-shaped reflective surfaces, further reflect parallel waves arrived from the first reflection part 1901 and the second reflection part 1902 to narrow passage sides (air intakes on the left and right sides) connected to the outside of the vehicle, and generate diffusion waves diffusing after being discharged to the outside of the vehicle through the narrow passages in two stages. In addition, the third reflection part 1903 and the fourth reflection part 1904 reflect high-frequency sound waves directly received from the high-frequency speaker 1802 to narrow passage sides (the air intakes on the left and right sides) connected to the outside of the vehicle, and generate diffusion waves diffusing after being discharged to the outside of the vehicle through the narrow passages in one stage.

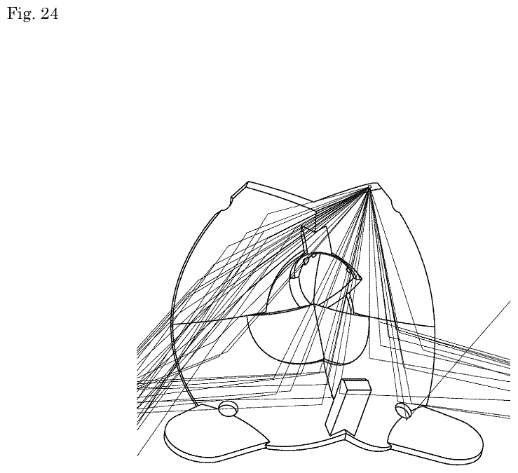

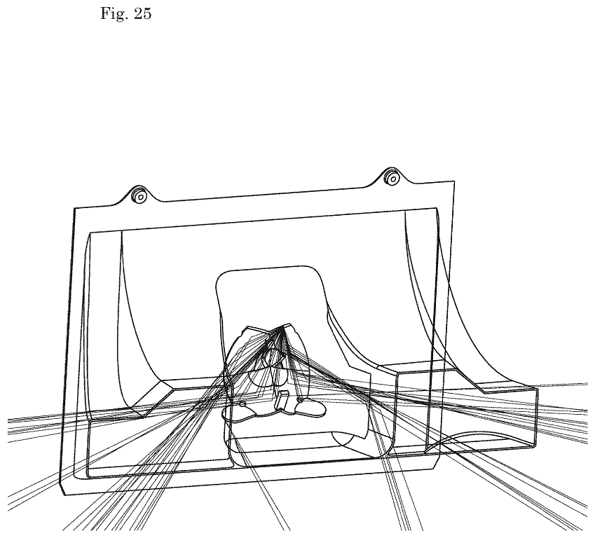

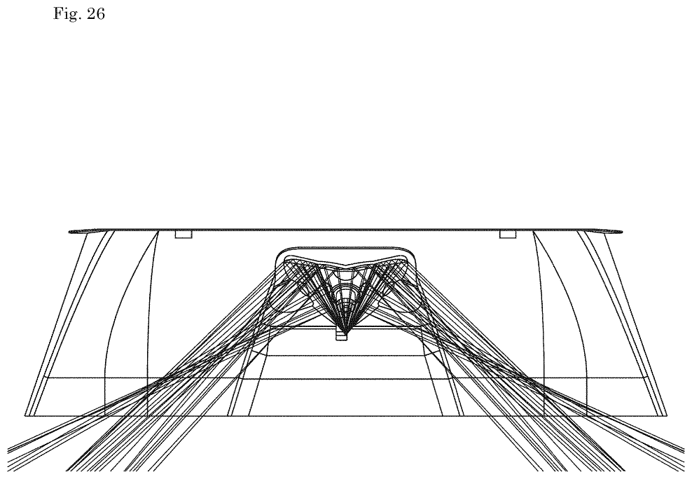

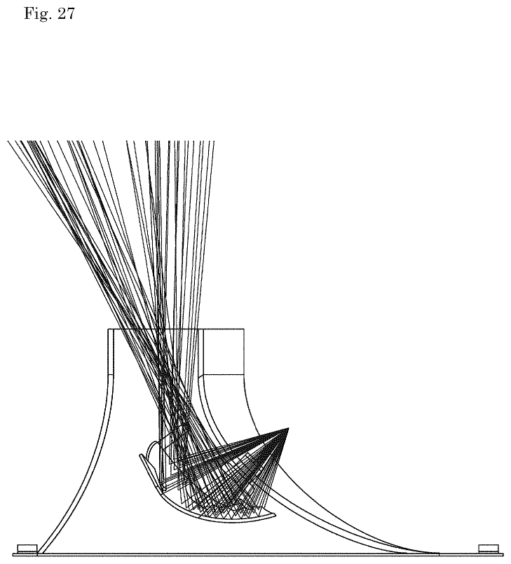

FIGS. 24 to 27 illustrate simulation results based on a sound ray analysis of sound rays discharged from the low-frequency speaker 1801. In the drawings, a plurality of sound rays discharged from the low-frequency speaker 1801 and traveling directions of sound rays after being reflected by the reflection plate 1702, which are acquired through a sound ray simulation, are drawn. Here, FIG. 24 illustrates a view in which sound rays discharged from the high-frequency speaker 1802 are reflected by the reflection parts 1901 to 1906 of the reflection plate 1702 in an enlarged scale. FIGS. 25 to 27 illustrate behaviors of sound rays discharged from the high-frequency speaker 1802 inside a front bumper. FIG. 25 illustrates a perspective view of the reflection plate 1702 from the front side, FIG. 26 illustrates a view of the reflection plate 1702 viewed from an upper side, and FIG. 27 illustrates a view of the reflection plate 1702 viewed from a lateral side.

As can be understood from FIGS. 24 to 27, the seventh reflection part 1907, the eighth reflection part 1908, the ninth reflection part 1909, and the tenth reflection part 1910 reflect low-frequency sound waves directly received from the low-frequency speaker 1801 to narrow passage sides (the air intakes on the left and right sides) connected to the outside of the vehicle and generate diffusion waves diffusing after being discharged to the outside of the vehicle through the narrow passages in one stage.

### C-2-2. Simulation Results of Reflection Plate

There is a risk of a rock and the like on the road surface entering the inside of the front bumper. In addition, the vehicle-external sound reproducing device according to this embodiment has a structure in which a sound from the speaker 1701 is reflected by the reflection plate 1702 to be radiated to the outside of the vehicle. When the reflection plate 1702 is deformed due to acoustic resonance, the reflection direction deviates from the narrow passage (the air intake), and a reflected sound cannot be radiated to the outside of the vehicle, whereby the sound pressure and the sound quality deteriorate. For this reason, the vehicle-external sound reproducing device according to this embodiment needs to have a sufficiently high mechanical strength and suppress acoustic resonance.

Thus, in this embodiment, materials and shapes of the casing (a grille part of at least the font side (or a sound discharge port)) of the speaker 1701 and the reflection plate 1702 that are main constituent components are optimized such that impacts of a stone and the like entering the inside of the front bumper is endured, and acoustic resonance can be reduced. Relating to the materials, the casing (a grille part of at least the font side (or a sound discharge port)) of the speaker 1701 and the reflection plate 1702, for example, are manufactured using high-strength engineering plastic such as glass-filled polycarbonate (PC) or the like. Engineering plastics have a high internal loss and contributes also to reduction of acoustic resonance. In addition, regarding reduction of acoustic resonance, the shape of the reflection plate 1702 is optimized such that all frequency modes reach 200 Hz or higher for which the amplitude becomes sufficiently small. Furthermore, a structure in which the grille part of the speaker 1701 and the reflection plate 1702 are connected at three places is employed. It is apparent that a structure in which the grille part of the speaker 1701 and the reflection plate 1702 are connected at four or more places may be employed. In addition, a configuration in which the speaker 1701 is disposed to be directed toward the rear side by using a reflected sound is employed, and thus the risk of damages in the speaker 1701 by being directly hit by a stone and the like entering the inside of the front bumper can be significantly reduced.

The following Table 1 illustrates a resonance frequency in each frequency mode of the reflection plate 1702 of which the material and the shape are optimized.

TABLE 1

| Number of models | Frequency [Hz] |
|---|---|
| 1 | 205.589 |
| 2 | 219.086 |
| 3 | 303.667 |
| 4 | 345.329 |
| 5 | 455.422 |
| 6 | 471.404 |
| 7 | 499.465 |
| 8 | 526.045 |
| 9 | 550.124 |
| 10 | 619.155 |

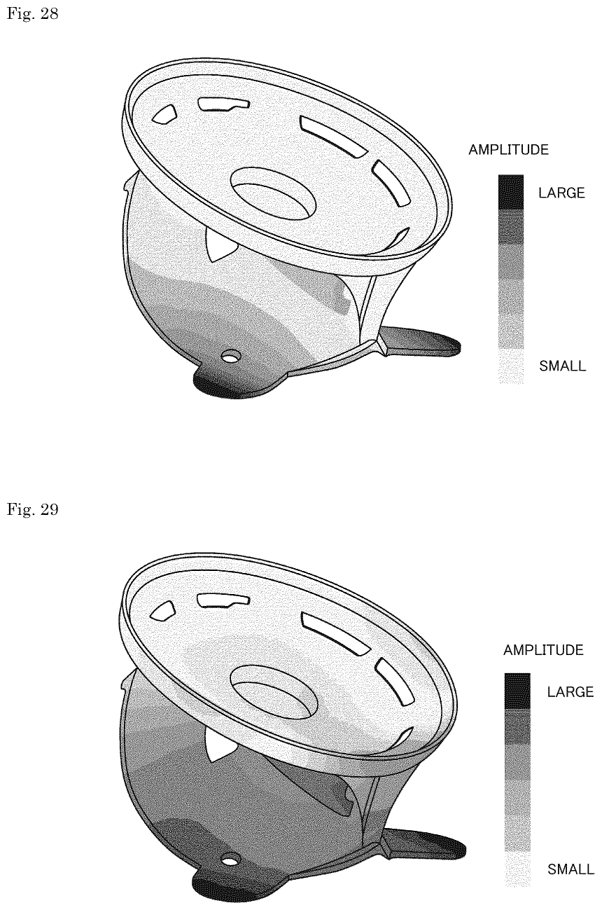

As illustrated in Table 1, it can be understood that the material and the shape are optimized such that the all frequency modes reach 200 Hz or higher for which the amplitude becomes sufficiently small. The resonance frequency is about 205 Hz in a first frequency mode, and the resonance frequency is about 219 Hz in a second frequency mode. FIGS. 28 and 29 illustrate vibration simulation results of the reflection plate 1702 and the speaker 1701 (only the grille part) in the first frequency mode and the second frequency mode. While the fifth reflection part 1905 and the sixth reflection part 1906 used for second-stage reflection of high-frequency sound waves are formed from tongue pieces protruding to outer sides of the eighth reflection part 1908 and the tenth reflection part 1910 (for example, see FIG. 19), they are cantilevered and have a larger amplitude than that the other parts.

### C-3. Measurement Results

In this Section C-3, the performance of the vehicle-external sound reproducing device according to this embodiment described in Section C-1 described above will be reviewed on the basis of actual measurement results.

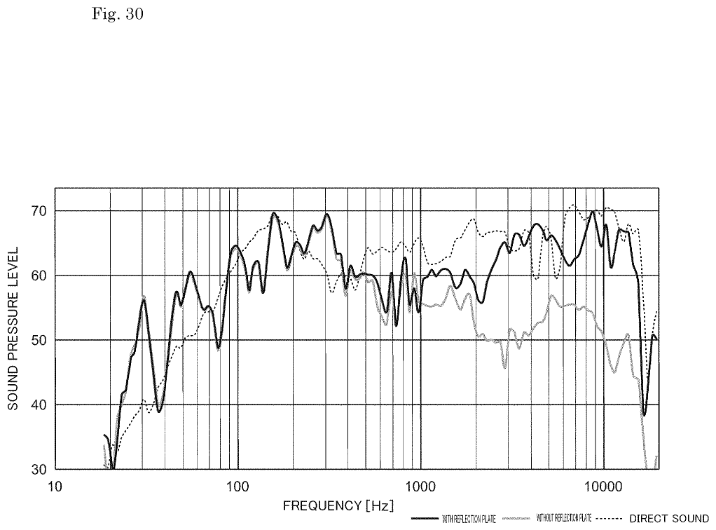

FIG. 30 illustrates a result of measuring a sound pressure level of a sounds (reflected sound) output from the vehicle-external sound reproducing device according to this embodiment by installing a microphone at the position (2.0 m to the lateral side from the vehicle traveling center line and at 1.2 m height above ground) specified in the R138 agreement regulations using a black solid line in the drawing. For comparison, a sound pressure level of a case in which the reflection plate 1702 is excluded is represented using a gray solid line in the drawing, and a sound pressure level of a sound (direct sound) output toward the front face of the speaker 1701 (without the reflection plate 1702) is illustrated using a black fine line in the drawing. In this drawing, the horizontal axis represents a frequency axis (Hz), and the vertical axis represents a sound pressure level (dB).

It can be understood that the sound pressure level (the black solid line) of the reflected sound of the vehicle-external sound reproducing device according to this embodiment is approximately equal to the sound pressure level (the black fine broken line) of the direct sound of a case in which the speaker 1701 is directed toward the front face (without reflection plate). In other words, even when the sound is reflected by the reflection plate, a level satisfying the requirements of the sound pressure of the vehicle-external sound can be maintained.

In addition, when the sound pressure level (the black solid line) of the vehicle-external sound reproducing device according to this embodiment is compared with the sound pressure level (the gray solid line) of a case without the reflection plate, an effect of improvement of 15 to 20 dB particularly in a high frequency range of 1 kHz or higher through directivity control using reflection according to the reflection plate can be checked. In other words, in a case in which the reflection plate 1702 is not provided, the sound pressure level cannot be maintained in the high-frequency range.

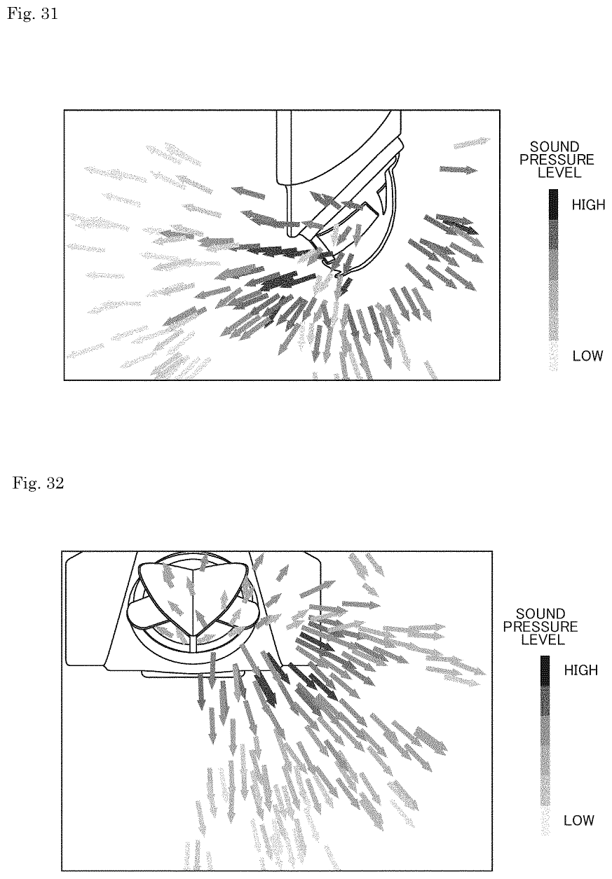

FIGS. 31 and 32 illustrate measurement results of intensities of sounds (reflected sounds) output from the vehicle-external sound reproducing device according to this embodiment. FIG. 31 illustrates a view of the reflection plate 1702 viewed from the lateral side, and FIG. 32 illustrates a view of the reflection plate 1702 viewed from the upper side. Here, the frequency of an output sound from the speaker 1701 is in the range of 1 kHz to 15 KHz.

In FIGS. 31 and 32, vectors representing the directions of sounds according to measurement of intensities are denoted by arrows. Here, the sound pressure level is expressed using shading, at a place having a higher sound pressure, the vector is drawn using a darker arrow, and at a place having a lower sound pressure, the vector is denoted by a lighter arrow.

FIGS. 22 and 23 illustrate simulation results of sound rays based on the sound ray analysis (see Section C-2-1 described above). When FIGS. 31 and 32 are compared with FIGS. 22 and 23, it can be checked that, as a result of actual measurement of intensities of reproduced sounds from the vehicle-external sound reproducing device according to this embodiment, the sound is radiated in a direction that is approximately the same as that of the simulation result.

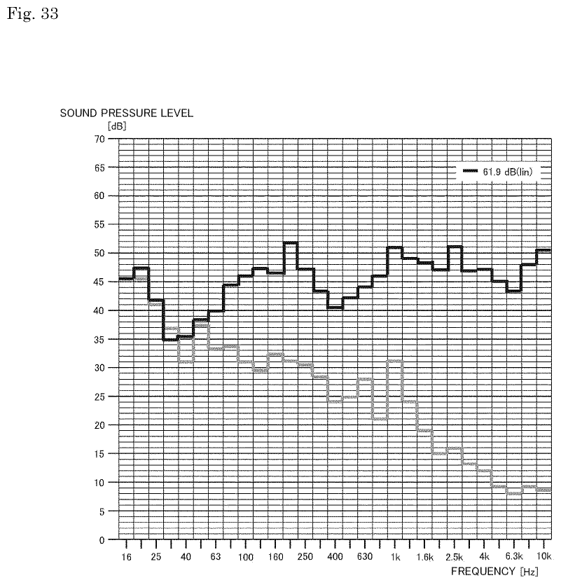

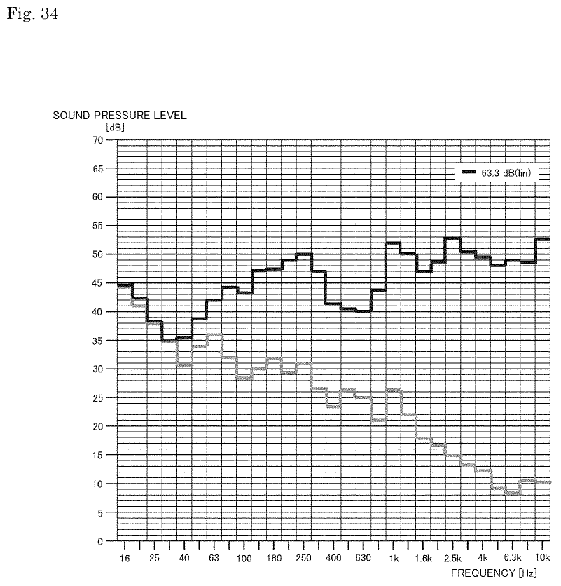

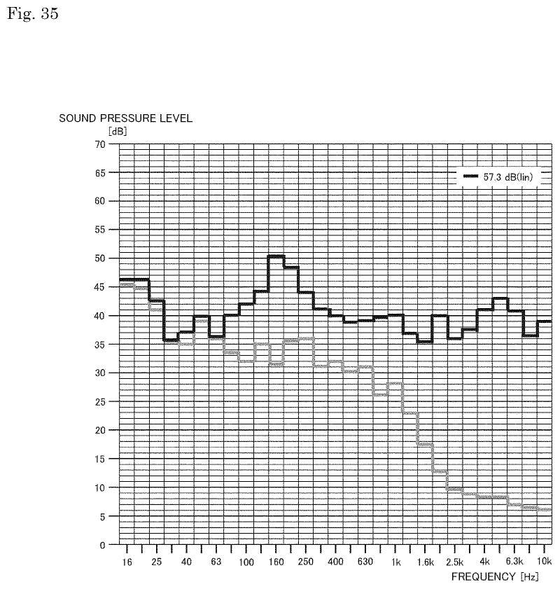

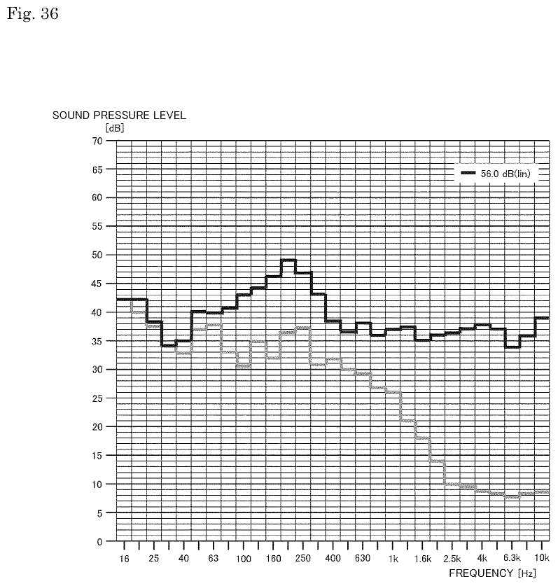

FIGS. 33 to 36 illustrate results of measuring sound pressure levels of radiated sounds from the vehicle-external sound reproducing device according to this embodiment by installing a microphone at a position specified in the R138 agreement regulations (2.0 m to the lateral side from the vehicle traveling center line and at a 1.2 m height above ground) on a vehicle left front side (FL), a vehicle right front side (FR), a vehicle left rear side (RL), and a vehicle left right side (RR). In each of the drawings, the horizontal axis represents a frequency axis, and the vertical axis represents a sound pressure level. A sound pressure level measured for each frequency band is denoted by a dark solid line, and, as a comparison target, a noise floor (dark noise) for each frequency band is denoted by a gray solid line. From such measurement results, it can be checked that radiated sounds of the vehicle-external sound reproducing device according to this embodiment exhibit sufficient sound pressure levels with respect to the noise floor on any one of the vehicle left front side (FL), the vehicle right front side (FR), the vehicle left rear side (RL), and the vehicle left right side (RR).

### C-4. Functional Configuration

### C-4-1. First Configuration Example

FIG. 37 schematically illustrates a functional configuration of a vehicle-external sound reproducing device according to this embodiment. The illustrated vehicle-external sound reproducing device 3700 includes a sound source part 3701, an equalizer (EQ) 3702, an amplification part 3703, a speaker part 3704, a reflection part 3705, a detection part 3706, a recognition part 3707, and a control part 3708.

The sound source part 3701 supplies a voice signal. Although the voice signal, for example, is a notification sound of an AVAS, for example, it may be an audio or the like targeted at a person present on the side of the vehicle. The sound source part 3701 may reproduce a voice signal from a recording medium such as a memory or the like or may acquire a voice signal from the outside through radio communication or the like.

The equalizer 3702 performs an equalization process on a voice signal supplied from the sound source part 3701, and the amplification part 3703 performs an amplification process on the equalized voice signal.

As illustrated in FIG. 18, the speaker part 3704 is formed from a coaxial-type speaker device in which a high-frequency (Tweeter) speaker is mounted on the front side on a center pole of a low-frequency (Woofer) speaker, can perform high sound quality reproduction in a broad frequency range, and can radiate a voice output from the speaker covering each frequency band from an approximate center of the low-frequency speaker. Since the speaker part 3704 is installed outside of the vehicle, it has a waterproof function.

As illustrated in FIG. 19, the reflection part 3705 is disposed on the front face (a radiation direction of sounds) of the speaker 3704, is formed from a reflection plate having a plurality of reflective surfaces reflecting a radiated sound from each of the low-frequency speaker and the high-frequency speaker of the coaxial form, and causes the sound to be radiated to the outside of the vehicle and through narrow passages (air intakes or the like) and diffuse. In FIG. 37, for simplification of the drawing, a detailed shape of the reflection plate is omitted. The reflection part 3705 causes sound rays output from the speaker 3704 to converge to pass through the narrow passages (the air intakes or the like) and reflects the sound rays to diffuse after radiation to the outside of the vehicle through passage.

The detection part 3706 is formed from an in-vehicle sensor and the like. The in-vehicle sensor includes an external recognition sensor, vehicle internal sensor, and a vehicle sensor. The detection part 3706 may use some of in-vehicle sensors equipped in a vehicle control system (described above).

The recognition part 3707 recognizes events occurring in the vehicle on the basis of a detection signal according to the detection part 3706. Events occurring in the vehicle are diverse. Here, in this embodiment, the recognition part 3707 is assumed to recognize at least events for which a vehicle-external sound needs to be output. The events for which an vehicle-external sound needs to be output includes an occurrence of an event for which a notification sound of an AVAS needs to be generated such as the speed becoming a regulation target vehicle speed specified in the R138 agreement regulations, an occurrence of an event for which a warning sound other than the AVAS needs to be generated in accordance with a pedestrian approaching the vehicle regardless of the vehicle speed, an occurrence of an event for which an answer-back needs to be notified such as locking or unlocking of doors, and the like. The recognition part 3707 may perform a recognition process, for example, using a machine learning model that has learned to estimate an event on the vehicle on the basis of a detection signal through deep learning.

The control part 3708 controls drive of each of the sound source part 3701, the equalizer 3702, the amplification part 3703, and the speaker part 3704 such that a vehicle-external sound with a volume, a sound tone, a melody, and the like that are appropriate for an event recognized by the recognition part 3707 is generated.

The control part 3708 may control drive of each part such that a sound with a different sound tone and a different melody is reproduced in accordance with the use such as output of a notification sound of an AVAS, an answer-back, or the like. For example, the sound tone or the melody of a vehicle approach notification sound may be switched between a case in which the vehicle is moving forward and a case in which the vehicle is moving backward. In addition, in an application to an answer-back function, the sound tone or melody of the reproduced sound may be finely switched, for example, between when the doors are locked and when the doors are unlocked.

### C-4-2. Second Configuration Example

Until now, a case in which the reflection plate 1702 is fixed on the front face of the speaker 1702, and a plurality of reflective surfaces included in the reflection plate 1702 have a fixed structure not changing the posture has been described. From the point of view of radiation of a notification sound satisfying requirements specified in the R138 agreement regulations, a reflection plate 1702 having a fixed structure may be used. As a modified example, by configuring the reflection plate 1702 to be a movable type with respect to the speaker 1701 and by configuring at least some of a plurality of reflective surfaces included in the reflection plate 1702 to be a movable type, a radiation direction control of sounds output from the speaker 1701 can be performed.

In a case in which the vehicle-external sound reproducing device according to this embodiment has a direction control function of radiated sounds, for example, applications of delivering an audio in a direction in which persons are present when having a barbeque beside the vehicle or delivering a notification sound to a pedestrian present in a traveling direction of the vehicle by changing the radiation direction of a sound in accordance with a steering angle of the steering wheel can be implemented.

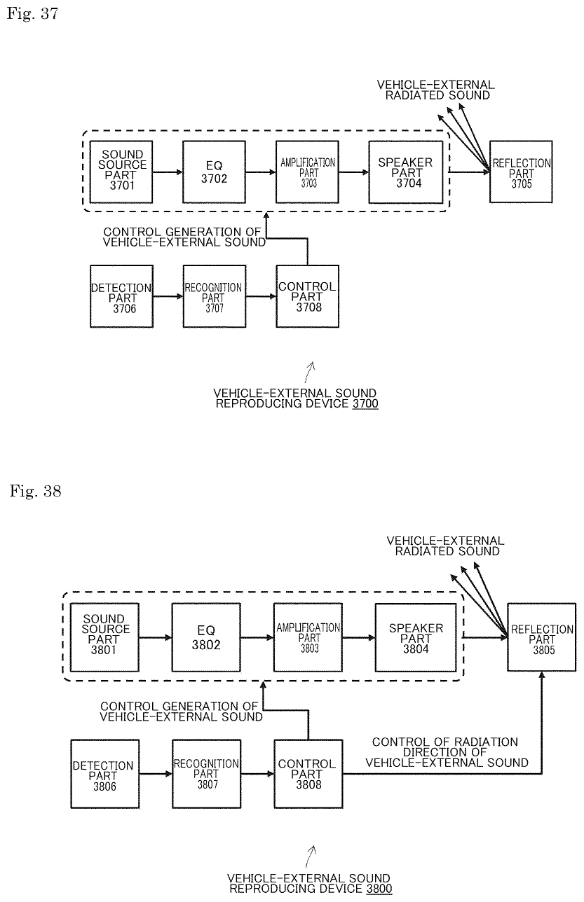

FIG. 38 schematically illustrates a functional configuration of a vehicle-external sound reproducing device according to this embodiment of a case in which direction control of a radiated sound is performed. The illustrated vehicle-external sound reproducing device 3800 includes a sound source part 3801, an equalizer 3802, an amplification part 3803, a speaker part 3804, a reflection part 3805, a detection part 3806, a recognition part 3807, and a control part 3808.

The sound source part 3801, the equalizer 3802, the amplification part 3803, the speaker part 3804, the detection part 3806, and the recognition part 3807 are similar to the constituent elements of the same names illustrated in FIG. 37, and thus description thereof will be omitted here.

The reflection part 3805 causes sound rays output from the speaker 3804 to converge to pass through narrow passages (air intakes or the like) and reflects the sound rays to diffuse after radiation to the outside of the vehicle through passage. While the reflection part 3805 is disposed on the front face (a radiation direction of sounds) of the speaker 3804 and is formed from a reflection plate having a plurality of reflective surfaces reflecting a radiated sound from each of a low-frequency speaker and a high-frequency speaker of a coaxial form, the reflection plate is configured to be movable, or at least some of the plurality of reflective surfaces are configured to be movable.

The control part 3808 controls drive of each of the sound source part 3801, the equalizer 3802, the amplification part 3803, and the speaker part 3804 and drive of each part of the reflection part 3805 such that a vehicle-external sound with a volume, a sound tone, a melody, and the like that are appropriate for an event recognized by the recognition part 3807 is generated.

The control part 3808 may control drive of each part such that a sound with a different sound tone and a different melody is reproduced in accordance with the use such as output of a notification sound of an AVAS, an answer-back, or the like. For example, the sound tone or the melody of a vehicle approach notification sound may be switched between a case in which the vehicle is moving forward and a case in which the vehicle is moving backward. In addition, in an application to an answer-back function, the sound tone or melody of the reproduced sound may be finely switched, for example, between when the doors are locked and when the doors are unlocked.

In addition, by using the radiation direction control based on drive of the reflection part 3805, the control part 3808 realizes an application of delivering an audio in a direction in which persons are present when having a barbeque beside the vehicle or delivering a notification sound to a pedestrian present in a traveling direction of the vehicle by changing the radiation direction of a sound in accordance with a steering angle of the steering wheel.

### INDUSTRIAL APPLICABILITY

The present disclosure has been described thus far in detail with reference to specific embodiments. However, it will be apparent to those skilled in the art that modifications, substitutions, and the like can be made in the embodiments without departing from the essential spirit of the present disclosure.

In the present specification, although the embodiment in which the vehicle-external sound reproducing device according to the present disclosure is disposed in a space inside the front bumper has been mainly described, the gist of the present disclosure is not limited thereto. For example, also in a case in which a vehicle-external sound generating device is configured by installing exciters in parts of the vehicle main body other than the front cover such as an air intake duct, an undercover, or the like, similarly, a notification sound of an AVAS satisfying the requirements specified in the R138 agreement regulations can be generated.

In addition, since the vehicle-external sound reproducing device according to the present disclosure can reproduce a diverse range of high-quality sounds, a sound with a different sound tone and a different melody can be reproduced in accordance with the use such as output of a notification sound of an AVAS, an answer-back, or the like. Furthermore, the vehicle-external sound reproducing device according to the present disclosure can transmit an audio in a direction of people around the vehicle.

In sum, the present disclosure has been described in the form of examples, and the content of the present specification is not intended to be interpreted as being limiting. The essential spirit of the present disclosure should be determined in consideration of the claims.

The present disclosure can also take on the configurations described below.
(1) A vehicle-external sound reproducing device including a sound reproducing part that is disposed inside a main body component of a vehicle and emits sound to outside of the vehicle.
(2) The vehicle-external sound reproducing device described in (1) described above, in which the sound reproducing part includes an exciter, and the exciter is installed on an inner wall of the main body component of the vehicle.
(3) The vehicle-external sound reproducing device described in (2) described above, in which the exciter is installed at a part at which a vehicle-external sound with a sound pressure level satisfying a predetermined requirement at a position with a predetermined distance and a predetermined height with respect to a traveling center line of the vehicle on the inner side of the main body component of the vehicle is able to be output.
(4) The vehicle-external sound reproducing device described in any one of (2) or (3) described above, in which the exciter is installed at least at one part of an inner wall of a front bumper, an air intake duct, and an undercover.
(5) The vehicle-external sound reproducing device described in any one of (2) to (4) described above, in which the exciter is installed via a stand formed as a flat structure near an installation position of the inner wall of the main body component of the vehicle.
(6) The vehicle-external sound reproducing device described in (1) described above, in which the sound reproducing part includes a speaker and a reflection plate that is installed in front of the speaker and reflects a radiated sound of the speaker.
(7) The vehicle-external sound reproducing device described in (6) described above, in which the sound reproducing part is disposed in a dead space in front of a radiator inside a front bumper.
(8) The vehicle-external sound reproducing device described in any one of (6) or (7) described above, in which the reflection plate reflects emitted sound of the speaker such that it converges to be able to pass through a narrow passage provided in the main body component of the vehicle and diffuses after passing through the narrow passage and being discharged to outside of the vehicle.
(9) The vehicle-external sound reproducing device described in any one of (6) to (8) described above, in which the speaker includes a high-frequency speaker and a low-frequency speaker that are coaxially disposed.
(10) The vehicle-external sound reproducing device described in (9) described above, in which the reflection plate includes a high-frequency sound reflective surface reflecting a radiated sound from the high-frequency speaker and a low-frequency sound reflective surface reflecting a radiated sound from the low-frequency speaker.
(11) The vehicle-external sound reproducing device described in (10) described above, in which the high-frequency sound reflective surface has a concave face-shaped reflection part reflecting sound waves arriving from the high-frequency speaker to generate parallel waves and a convex face-shaped reflection part reflecting the parallel wave to a narrow passage side connected to the outside of the vehicle and generating a diffusion wave diffusing after being discharged to the outside of the vehicle through the narrow passage.
(12) The vehicle-external sound reproducing device described in (11) described above, in which the high-frequency sound reflective surface further has a concave face-shaped reflection part that directly reflects a sound wave delivered from the high-frequency speaker to the narrow passage side and generates a diffusion wave diffusing after being discharged to the outside of the vehicle through the narrow passage.
(13) The vehicle-external sound reproducing device described in any one of (10) to (12) described above, in which the low-frequency sound reflective surface has a concave face-shaped reflection part that directly reflects a sound wave delivered from the low-frequency speaker to the narrow passage side and generates a diffusion wave diffusing after being discharged to the outside of the vehicle through the narrow passage.
(14) The vehicle-external sound reproducing device described in any one of (11) to (13) described above, in which the concave face shape is formed from a parabola curved face for which an appropriate aperture ratio is applied.
(15) The vehicle-external sound reproducing device described in any one of (10) to (14) described above, in which the low-frequency sound reflective surface is disposed on an outer side of the high-frequency sound reflective surface.
(16) The vehicle-external sound reproducing device described in any one of (6) to (15) described above, in which at least one of a casing of the speaker and the reflection plate is composed of glass-filled polycarbonate or another engineering plastic.
(17) The vehicle-external sound reproducing device described in any one of (6) to (16) described above, in which the reflection plate is configured such that a resonance frequency is 200 Hz or higher in all frequency modes.
(18) The vehicle-external sound reproducing device described in any of (1) to (17) described above, further including a control part controlling a sound reproduction operation performed using the sound reproducing part.
(19) The vehicle-external sound reproducing device described in (18) described above, in which the control part controls the sound reproduction operation performed using the sound reproducing part in accordance with an event occurring in the vehicle.
(19-1) The vehicle-external sound reproducing device described in (19) described above, in which the control part controls the sound reproduction operation performed using the sound reproducing part including at least one of a sound tone, a melody, and a radiation direction in accordance with an event occurring in the vehicle.
(20) A vehicle device including: a main body component; and a sound reproducing part that is disposed on an inner side of the main body component and radiates a sound to an outside of a vehicle.

### REFERENCE SIGNS LIST

1201 Air intake duct
1202, 1203 Undercover
1300 Front bumper
1301, 1302 Exciter
1400 Vehicle-external sound reproducing device
1401 Vehicle main body component
1402 Exciter
1403 Detection part
1404 Recognition part
1405 Drive control part
1500, 1600, 1700 Vehicle-external sound reproducing device
1701 Speaker
1702 Reflection plate
1801 Speaker (low-frequency sound side)
1802 Speaker (high-frequency sound side)
3700 Vehicle-external sound reproducing device
3701 Sound source part
3702 Equalizer
3703 Amplification part
3704 Speaker part
3705 Reflection part
3706 Detection part
3707 Recognition part
3708 Control part
3800 Vehicle-external sound reproducing device
3801 Sound source part
3802 Equalizer
3803 Amplification part
3804 Speaker part
3805 Reflection part
3806 Detection part
3807 Recognition part
3808 Control part
3900 Exciter
3901 Main body part
3902 Frame part
3903 Lead wire
4100 Stand

What is claimed is:

1. A vehicle-external sound reproducing device comprising a sound reproducing part that is disposed inside a main body component of a vehicle and emits sound to outside of the vehicle.

2. The vehicle-external sound reproducing device according to claim 1, wherein the sound reproducing part includes an exciter, and the exciter is installed on an inner wall of the main body component of the vehicle.

3. The vehicle-external sound reproducing device according to claim 2, wherein the exciter is installed at a part at which a vehicle-external sound with a sound pressure level satisfying a predetermined requirement at a position with a predetermined distance and a predetermined height with respect to a traveling center line of the vehicle on the inner side of the main body component of the vehicle is able to be output.

4. The vehicle-external sound reproducing device according to claim 2, wherein the exciter is installed at least at one part of an inner wall of a front bumper, an air intake duct, and an undercover.

5. The vehicle-external sound reproducing device according to claim 2, wherein the exciter is installed via a stand formed as a flat structure near an installation position of the inner wall of the main body component of the vehicle.

6. The vehicle-external sound reproducing device according to claim 1, wherein the sound reproducing part includes a speaker and a reflection plate that is installed in front of the speaker and reflects a radiated sound of the speaker.

7. The vehicle-external sound reproducing device according to claim 6, wherein the sound reproducing part is disposed in a dead space in front of a radiator inside a front bumper.

8. The vehicle-external sound reproducing device according to claim 6, wherein the reflection plate reflects emitted sound of the speaker such that it converges to be able to pass through a narrow passage provided in the main body component of the vehicle and diffuses after passing through the narrow passage and being discharged to outside of the vehicle.

9. The vehicle-external sound reproducing device according to claim 6, wherein the speaker includes a high-frequency speaker and a low-frequency speaker that are coaxially disposed.

10. The vehicle-external sound reproducing device according to claim 9, wherein the reflection plate includes a high-frequency sound reflective surface reflecting a radiated sound from the high-frequency speaker and a low-frequency sound reflective surface reflecting a radiated sound from the low-frequency speaker.

11. The vehicle-external sound reproducing device according to claim 10, wherein the high-frequency sound reflective surface has a concave face-shaped reflection part reflecting sound waves arriving from the high-frequency speaker to generate parallel waves and a convex face-shaped reflection part reflecting the parallel wave to a narrow passage side connected to the outside of the vehicle and generating a diffusion wave diffusing after being discharged to the outside of the vehicle through the narrow passage.

12. The vehicle-external sound reproducing device according to claim 11, wherein the high-frequency sound reflective surface further has a concave face-shaped reflection part that directly reflects a sound wave delivered from the high-frequency speaker to the narrow passage side and generates a diffusion wave diffusing after being discharged to the outside of the vehicle through the narrow passage.

13. The vehicle-external sound reproducing device according to claim 10, wherein the low-frequency sound reflective surface has a concave face-shaped reflection part that directly reflects a sound wave delivered from the low-frequency speaker to the narrow passage side and generates a diffusion wave diffusing after being discharged to the outside of the vehicle through the narrow passage.

14. The vehicle-external sound reproducing device according to claim 11, wherein the concave face shape is formed from a parabola curved face for which an appropriate aperture ratio is applied.

15. The vehicle-external sound reproducing device according to claim 10, wherein the low-frequency sound reflective surface is disposed on an outer side of the high-frequency sound reflective surface.

16. The vehicle-external sound reproducing device according to claim 6, wherein at least one of a casing of the speaker and the reflection plate is composed of glass-filled polycarbonate or another engineering plastic.

17. The vehicle-external sound reproducing device according to claim 6, wherein the reflection plate is configured such that a resonance frequency is 200 Hz or higher in all frequency modes.

18. The vehicle-external sound reproducing device according to claim 1, further comprising a control part controlling a sound reproduction operation performed using the sound reproducing part.

19. The vehicle-external sound reproducing device according to claim 18, wherein the control part controls the sound reproduction operation performed using the sound reproducing part in accordance with an event occurring in the vehicle.

20. A vehicle device comprising:
a main body component; and
a sound reproducing part that is disposed on an inner side of the main body component and radiates a sound to an outside of a vehicle.
